(19) United States
(12) Patent Application Publication
(10) Pub. No.: US 2010/0239891 A1
(43) Pub. Date: Sep. 23, 2010

(54) MAGNETIC RECORDING MEDIUM

(75) Inventors: Kazufumi OMURA, Kanagawa (JP); Masami Sato, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/729,884

(22) Filed: Mar. 23, 2010

(30) Foreign Application Priority Data
Mar. 23, 2009 (JP) 2009-070148
Mar. 31, 2009 (JP) 2009-087450

(51) Int. Cl. G11B 5/708

(52) U.S. Cl. 428/842

(57) ABSTRACT

An aspect of the present invention relates to a magnetic recording medium comprising a magnetic layer comprising a ferromagnetic powder and a binder on a nonmagnetic support, wherein the magnetic layer comprises compound A and/or a ring-opened product of compound A. Another aspect of the present invention relates to a magnetic recording medium comprising a nonmagnetic layer comprising a nonmagnetic powder and a binder and a magnetic layer comprising a ferromagnetic powder and a binder in this order on a nonmagnetic support, wherein the nonmagnetic layer comprises compound A and/or a ring-opened product of compound A. Compound A comprises a lactone ring substituted with at least one polar group selected from the group consisting of a hydroxyl group, a carboxyl group, and an amino group, or substituted with a substituent comprising the above polar group.

### CROSS-REFERENCE TO RELATED APPLICATIONS

This application claims the benefit of priority under 35 USC 119 to Japanese Patent Application No. 2009-70148 filed on Mar. 23, 2009 and Japanese Patent Application No. 2009-87450 filed on Mar. 31, 2009, which are expressly incorporated herein by reference in their entirety.

### BACKGROUND OF THE INVENTION

1. Field of the Invention

The present invention relates to a magnetic recording medium, and more particularly, to a magnetic recording medium having excellent surface smoothness.

2. Discussion of the Background

In recent years, methods of transmitting information at high speed have developed markedly, making it possible to transmit images and data comprised of immense amounts of information. As data transmission technology has improved, there has been a demand to further increase the recording density of recording and reproduction devices and recording media for recording, reproducing, and storing information.

The use of microparticulate magnetic powder, the high-degree dispersion of microparticulate magnetic powder, and increasing the smoothness of the surface of the magnetic layer are known to be effective ways of achieving good electromagnetic characteristics in the field of high-density recording. A magnetic recording medium with a high degree of luster can be obtained by enhancing the dispersibility of the magnetic powder. An effective means of increasing the smoothness of the surface of the magnetic layer is to increase the dispersibility of the nonmagnetic powder contained in the nonmagnetic layer positioned beneath the magnetic layer.

The method of incorporating a polar group such as —SO₃Na into a binder (see Japanese Unexamined Patent Publication (KOKAI) No. 2003-132531 or English language family member U.S. Pat. No. 6,377,036, which are expressly incorporated herein by reference in their entirety) and the method of employing additives (dispersing agents) are widely employed to increase the dispersibility of the powders, such as magnetic powder, employed in magnetic recording media. For example, Japanese Examined Patent Publication (KOKOKU) Heisei No. 7-85305 or English language family member U.S. Pat. No. 4,885,208 and Japanese Unexamined Patent Publication (KOKAI) Heisei No. 1-232530, which are expressly incorporated herein by reference in their entirety, describe the use of cinnamic acid and benzoic acid as dispersing agents. Japanese Unexamined Patent Publication (KOKAI) Heisei No. 6-301965, which is expressly incorporated herein by reference in its entirety, describes cinnamic acid as a component capable of suppressing the error rate by preventing corrosion of the head surface.

To enhance the dispersibility of the powder in systems comprising powder and binder, it is important to increase adsorption of the binder to the powder surface. However, the binders employed in coating liquids for forming magnetic recording media for example, are generally highly hydrophobic, while the surface of the powders employed in the coating liquid are highly hydrophilic. Under these conditions, the binder tends not to adsorb to the surface of the powder. By contrast, incorporating a polar group into the binder as mentioned above may have the effect of causing the binder to efficiently adsorb to the surface of the powder due to the compatibility of the polar group to the powder surface. This effect tends to increase with the number of polar groups incorporated into the binder. However, when the quantity of polar groups in the binder becomes excessive, association between polar groups may run the risk of increasing the viscosity of the coating liquid and compromising dispersibility. Additionally, the dispersion-enhancing effect of cinnamic acid and the like may not be necessarily adequate in magnetic recording media for high-density recording in which a high degree of surface smoothness is required.

### SUMMARY OF THE INVENTION

An aspect of the present invention provides for a magnetic recording medium with excellent surface smoothness achieved by enhancing the dispersion of powders such as magnetic powder in magnetic coating materials and nonmagnetic powder in nonmagnetic coating materials.

To achieve the above-stated magnetic recording medium, the present inventors conducted extensive research into finding ways to increase the level of binder adsorption to the surface of powder by modifying the surface of the powder. As a result, they discovered that by employing a compound comprising a lactone ring and at least one polar group selected from the group consisting of a hydroxyl group, a carboxyl group, and an amino group, or by combining such a compound with a compound comprising an unsaturated bond and a carboxyl group, it was possible to increase the level of binder adsorption to the surface of the powder in a system containing a powder and a binder. The present inventors presumed the reasons for this to be as follows.

Adsorbed water is known to be present on the surface of magnetic powder and nonmagnetic powder. This adsorbed water is thought to contribute to hydrophilic properties. Additionally, a lactone ring opens while breaking down water when in the presence of water. It is thought that compounds that contain lactone rings undergo this ring-opening reaction while breaking down adsorbed water when they come into contact with the surface of a powder, thereby lowering the quantity of adsorbed water on the powder surface and thus increasing the hydrophobic property of the powder surface. The present inventors presume that utilization of the effect of increasing the hydrophobic property of the powder surface in this manner to increase the adsorptivity of hydrophobic binder might be why a compound containing a lactone ring increases the level of adsorption of binder on the powder. Here, the polar group that is contained in the compound comprising a lactone ring is thought to function to increase compatibility between the lactone ring compound and the powder surface, and promote contact and adsorption of the lactone ring-containing compound to the powder surface.

In the compound containing an unsaturated bond and a carboxyl group that can be employed in combination with the lactone ring-comprising compound, the fact that adsorption to the powder surface is possible due to the carboxyl group and the fact that compatibility with the binder is high because of containing an unsaturated bond are thought to have the effect of increasing compatibility between the powder surface and the binder. However, the surface modifying effect resulting from above is not necessarily adequate in magnetic recording media for high-density recording. This is presumed to be because compatibility with the hydrophobic binder is inadequate due to the surfaces of magnetic powders and nonmagnetic powders being hydrophilic, despite the use of a compound containing an unsaturated bond. Accordingly, by employing the compound containing an unsaturated bond with the lactone ring-comprising compound, it is possible to increase the level of adsorption of the binder to the powder surface.

The present invention was devised on that basis.

An aspect of the present invention relates to a magnetic recording medium comprising a magnetic layer comprising a ferromagnetic powder and a binder on a nonmagnetic support, wherein the magnetic layer comprises a compound, referred to as “compound A”, hereinafter, and/or a ring-opened product of compound A. Compound A comprises a lactone ring substituted with at least one polar group selected from the group consisting of a hydroxyl group, a carboxyl group, and an amino group, or substituted with a substituent comprising the above polar group.

The magnetic layer may further comprise a compound, referred to as “compound B”, hereinafter, comprising an unsaturated bond and a carboxyl group.

Compound A may be a compound denoted by general formula (I) or (II).

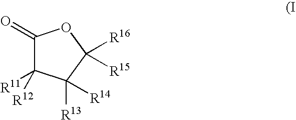

In general formula (I), each of R¹¹ to R¹⁶ independently denotes a hydrogen atom or a substituent, with at least one from among R¹¹ to R¹⁶ denoting at least one polar group selected from the group consisting of a hydroxyl group, carboxyl group, and amino group, or a substituent comprising the polar group

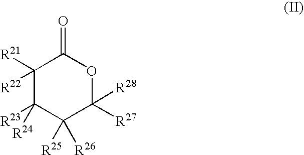

In general formula (II), each of R²¹ to R²⁸ independently denotes a hydrogen atom or a substituent, with at least one from among R²¹ to R²⁸ denoting at least one polar group selected from the group consisting of a hydroxyl group, carboxyl group, and amino group, or a substituent comprising the polar group.

The polar group comprised in compound A may be a hydroxyl group.

Compound A may comprise at least two hydroxyl groups per molecule.

Compound B may be an unsaturated fatty acid.

Compound B may be an aromatic compound.

The aromatic compound may comprise a benzene ring or naphthalene ring.

The magnetic layer may comprise a reaction product of compound A and/or the ring-opened product of compound A with an isocyanate compound.

A further aspect of the present invention relates to a magnetic recording medium comprising a nonmagnetic layer comprising a nonmagnetic powder and a binder and a magnetic layer comprising a ferromagnetic powder and a binder in this order on a nonmagnetic support, wherein the nonmagnetic layer comprises compound A and/or a ring-opened product of compound A. The nonmagnetic layer may comprise a reaction product of compound A and/or the ring-opened product of compound A with an isocyanate compound.

The nonmagnetic layer may comprise compound B.

The magnetic layer may comprise compound A and further comprise compound B.

The present invention can provide a magnetic recording medium having good surface smoothness, in which the surface of the powder is modified to increase the level of adsorption of binder to powder, thereby increasing the dispersibility of magnetic powder in the magnetic coating material and of nonmagnetic powder in the nonmagnetic coating material.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Recording Medium

An aspect of the present invention relates to a magnetic recording medium comprising a magnetic layer comprising a ferromagnetic powder and a binder on a nonmagnetic support, wherein the magnetic layer comprises compound A and/or a ring-opened product of compound A. Compound A comprises a lactone ring substituted with at least one polar group selected from the group consisting of a hydroxyl group, a carboxyl group, and an amino group, or substituted with a substituent comprising the above polar group.

Another aspect of the present invention relates to a magnetic recording medium comprising a nonmagnetic layer comprising a nonmagnetic powder and a binder and a magnetic layer comprising a ferromagnetic powder and a binder in this order on a nonmagnetic support, wherein the nonmagnetic layer comprises compound A and/or a ring-opened product of compound A.

In both aspects, the layer containing compound A and/or a ring-opened product thereof, may further comprise a compound B in the form of a compound comprising an unsaturated bond and a carboxyl group. Further, in the embodiment in which the nonmagnetic layer comprises compound A and/or a ring-opened product thereof, and any compound B, these compounds can also be contained in the magnetic layer.

As set forth above, the fact that compound B is capable of adsorbing to the powder surface by means of a carboxyl group and the fact that it is highly compatible with the binder because of containing an unsaturated bond are thought to increase compatibility between the powder surface and the binder. However, the resulting surface-modifying effect may not be necessarily adequate in a magnetic recording medium for high-density recording. This is presumed to result from inadequate compatibility with the hydrophobic binder, despite the use of compound B, because the surfaces of magnetic powder and nonmagnetic powder are hydrophilic.

The hydrophilic property of the surfaces of magnetic powders and nonmagnetic powders is thought to be caused by the presence of adsorbed water on the surfaces of the powders. Additionally, the lactone ring contained in compound A opens while breaking down water when in the presence of water. Compound A may undergo this ring-opening reaction while breaking down adsorbed water when it comes into contact with the powder surface. As a result, the quantity of adsorbed water on the powder surface is thought to decrease, making it possible to enhance the hydrophobic property of the powder surface. The present inventors surmised that the increase in adsorptivity to hydrophobic binder due to the effect of increasing the hydrophobic property of the powder surface by compound A might be the reason for which it is possible to increase the level of adsorption of binder to powder through the use of compound A containing a lactone ring. Here, one of the polar group contained in compound A was thought to increase the compatibility of compound A and the powder surface, playing the role of promoting contact and adsorption of compound A to the surface of the powder.

As the result of further investigation conducted by the present inventors, it was discovered that employing a compound A containing two or more hydroxyl groups per molecule with an isocyanate compound had the effect of increasing film strength. The reasons for this were presumed to be as follows.

Polyurethane is widely employed as a binder in magnetic recording media. Polyurethane is a polymer of great mechanical strength due to the hydrogen bonds between molecules, but contains almost no functional groups capable of reacting with isocyanate, such as hydroxyl groups. Thus, even when an isocyanate compound is employed as a curing agent, it is difficult to greatly increase the coating strength. Additionally, compound A generates one mole equivalent of hydroxyl groups in the course of ring opening. However, monofunctional alcohol may cap the ends of the isocyanate curing agent, preventing curing. By contrast, when compound A contains another hydroxyl group in addition to the hydroxyl group used for adsorption, the excess hydroxyl group can react with the isocyanate group, and is thought to promote a good curing reaction. The reason the use of a compound A containing two or more hydroxyl groups per molecule can form a high-strength coating is thought to arise from the fact that the curing rate is increased by the above curing reaction.

A layer containing powder (ferromagnetic powder or nonmagnetic powder) the surface of which has been modified with above-described compound A contains unreacted compound A and/or the ring-opened product of compound A that has undergone ring opening through contact with the powder surface. A layer formed by employing compound A and an isocyanate compound in combination may contain compound A and/or its ring-opened products, as well as reaction products with the isocyanate compound.

For example, as indicated in Examples set forth further below, the presence or absence of compounds A (and optionally compound B) changes the level of adsorption of binder to the powder in the coating material, thereby confirming that these compounds modify the surface of the powder. By modifying the powder surface in this fashion, it is possible to increase the smoothness of the surface by increasing dispersion of the powder within the layer.

Compounds A and B will be described in greater detail below.

### Compound A (Lactone-Ring Containing Compound)

Compound A comprises a lactone ring that is substituted with at least one polar group selected from the group consisting of a hydroxyl group, carboxyl group, and amino group, or with a substituent comprising such a polar group. The lactone ring is not specifically limited other than that it comprise an ester bond in a part of the ring thereof. From the perspective of the powder surface-modifying effect, a five or six-membered lactone ring is desirable.

The lactone ring contained in compound A is substituted with at least one polar group selected from the group consisting of a hydroxyl group (—OH), carboxyl group (—COOH), and an amino group, or with a substituent containing such a polar group. The polar group may be any from among a hydroxyl group, a carboxyl group, and an amino group, and will increase the compatibility of the binder with the powder surface so long as one such polar group is contained per molecule. The compound may contain two or more such polar groups, that are identical or different, per molecule. The number of polar groups per molecule is not specifically limited; examples are 1 to 4.

Compound A is capable of adsorbing to the surface of the powder through the effect of the polar group, so long as it contains one of the above polar groups per molecule, and as a result, is thought to have the effect of enhancing the hydrophobic property of the powder surface, as set forth above. Additionally, curing agents (crosslinking agents) in the form of isocyanate compounds are normally contained in coating liquids for forming magnetic recording media. Among the above polar groups, hydroxyl groups and amino groups can form urethane bonds (a crosslinked structure) by reacting with the isocyanate group of the isocyanate compound. Accordingly, in a coating liquid for forming a magnetic recording medium containing an isocyanate compound, the incorporation of a large number of hydroxyl groups and/or amino groups that contribute to the adsorption of the compound to the powder surface is though to permit the excess hydroxyl groups and/or amino groups to form urethane bonds by reacting with the isocyanate compound. When the compound present on the powder surface and the isocyanate compound form a crosslinked structure in this manner, it is possible to increase the strength of the coating formed by the coating liquid. From these perspectives, compound A desirably comprises two or more polar groups selected from among a hydroxyl group and an amino group per molecule. When considering reactivity with isocyanate compounds, compound A desirably comprises two or more hydroxyl groups per molecule, and may contain, for example, 2 to 4 hydroxyl groups. Since compound A generates a hydroxyl group by opening of the lactone ring, this hydroxyl group is also thought to form a crosslinked structure with the isocyanate compound, contributing to increased coating strength. The isocyanate compound will be described in greater detail below.

Examples of the amino group are an unsubstituted amino group (—NH₂) as well as single-substituted and double-substituted amino groups. Examples of substituted amino groups are monomethyl amino groups, dimethyl amino groups, and diphenyl amino groups. From the perspectives of adsorptivity to the powder surface and reactivity with the isocyanate compound, an unsubstituted amino group is desirable.

The substituent containing at least one polar group selected from the group consisting of a hydroxyl group, a carboxyl group, and an amino group that can be incorporated in compound A is not specifically limited. Examples are alkyl groups and aryl groups that have been substituted with such a polar group. From the perspective of reactivity with the isocyanate compound, the substituent desirably comprises a hydroxyl group, preferably a primary hydroxyl group, and more preferably, an alkyl group comprising a primary hydroxyl group.

The alkyl group may be linear, branched, or cyclic, and may be an alkyl group comprising, for example, 1 to 30 carbon atoms. Specific examples are: a methyl group, ethyl group, n-propyl group, isopropyl group, t-butyl group, n-octyl group, eicosyl group, 2-chloroethyl group, 2-cyanoethyl group, or 2-ethylhexyl group. Further examples are cycloalkyl groups (for example, substituted or unsubstituted cycloalkyl groups having 3 to 30 carbon atoms, specifically, a cyclohexyl group, cyclopentyl group, or 4-n-dodecylcyclohexyl group), bicycloalkyl groups (for example, substituted or unsubstituted bicycloalkyl groups having 5 to 30 carbon atoms, that is, a monovalent group obtained by removing a hydrogen atom from a bicycloalkane having to 30 carbon atoms; specifically, bicyclo[1,2,2]heptane-2-yl or bicyclo[2,2,2]octane-3-yl), and higher cyclic structures, such as tricyclic structures. In the present invention, the “number of carbon atoms” of a given group refers to the number of carbon atoms excluding substituents when such are present on the group.

The above aryl group is a substituted or unsubstituted aryl group, such as a substituted or unsubstituted aryl group having 6 to 30 carbon atoms. Specific examples are: phenyl groups, p-tolyl groups, naphthyl groups, m-chlorophenyl groups, and o-hexadecanoylaminophenyl groups.

From the perspective of reactivity with adsorbed water on the powder surface, an alkyl group with 1 to 3 carbon atoms, such as a methyl group, ethyl group, or propyl group is desirable.

From the perspective of the powder surface-modifying effect, compound A is desirably a five-membered lactone ring-containing compound denoted by general formula (I) or a six-membered lactone ring-containing compound denoted by general formula (II) below.

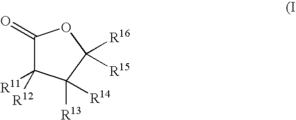

In general formula (I), each of R¹¹ to R¹⁶ independently denotes a hydrogen atom or a substituent, with at least one from among R¹¹ to R¹⁶ denoting at least one polar group selected from the group consisting of a hydroxyl group, carboxyl group, and amino group, or a substituent comprising such a polar group).

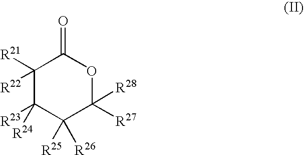

In general formula (II), each of R²¹ to R²⁸ independently denotes a hydrogen atom or a substituent, with at least one from among R²¹ to R²⁸ denoting at least one polar group selected from the group consisting of a hydroxyl group, carboxyl group, and amino group, or a substituent comprising such a polar group).

The compounds denoted by general formulas (I) and (II) will be described in greater detail below.

In general formula (I), each of R¹¹ to R¹⁶ independently denotes a hydrogen atom or a substituent, with at least one from among R¹¹ to R¹⁶ denoting (i) at least one polar group selected from the group consisting of a hydroxyl group, carboxyl group, and amino group, or (ii) a substituent comprising such a polar group. The details of (i) and (ii) are as set forth above. A substituent denoted by any of R¹¹ to R¹⁶ that is other than (i) or (ii) is not specifically limited; examples are aryl groups (desirably a substituted or unsubstituted aryl group having 6 to 30 carbon atoms, such as a phenyl group, tolyl group, xylyl group, mesityl group, biphenylyl group, naphthyl group, anthryl group, phenanthryl group, fluorenyl group, or pyrenyl group); and alkyl groups (desirably a substituted or unsubstituted alkyl group having 1 to 20 carbon atoms, such as a methyl group, ethyl group, propyl group, isopropyl group, n-butyl group, sec-butyl group, tert-butyl group, n-pentyl group, neopentyl group, hexyl group, heptyl group, octyl group, nonyl group, decyl group, undecyl group, dodecyl group, cyclopentyl group, cyclohexyl group, benzyl group, phenethyl group, diphenylmethyl group, or trityl group).

In general formula (II), each of R²¹ to R²⁸ independently denotes a hydrogen atom or a substituent, with at least one from among R²¹ to R²⁸ denoting (i) at least one polar group selected from the group consisting of a hydroxyl group, carboxyl group, and amino group, or (ii) a substituent comprising such a polar group. The details of (i) and (ii) are as set forth above. The details of a substituent denoted by any of R²¹ to R²⁸ that is other than (i) or (ii) are as set forth above.

The lactone ring-containing compounds corresponding to compound A that are denoted by either general formula (I) or (II) can be readily synthesized by known methods and are available as commercial products.

Specific examples of compound A are given below. However, the present invention is not limited to the specific examples given below.

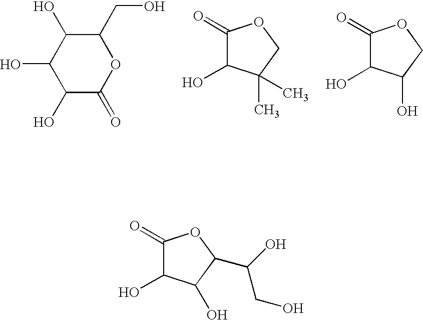

### Compound B

Compound B comprises an unsaturated bond and a carboxyl group. The unsaturated bond in compound B is, for example, a double bond. It is also conceivable for a II-II interaction to occur between the unsaturated bond and an unsaturated bond in the binder, increasing the bond strength and contributing to improved dispersibility.

From the perspective of compatibility with the binder, compound B desirably comprises a double bond as the unsaturated bond, and is preferably an unsaturated fatty acid or comprises an unsaturated bond in a cyclic structure such as an aromatic compound. Only one unsaturated bond need be contained in compound B, but the number of such bonds contained is not specifically limited.

From the perspective of solubility in solvent, an unsaturated fatty acid having about 5 to 30 carbon atoms is desirable as the unsaturated fatty acid. Specific examples are oleic acid, palmitoleic acid, linolic acid, and linolenic acid.

The ring structure that can be contained in compound B may be a single ring or a condensed ring, and may be an aromatic ring, aliphatic ring, or heterocyclic ring. Examples of aromatic rings are benzene rings, naphthalene rings, anthracene rings, and phenanthrene rings. An example of an aliphatic ring is a cyclohexane ring. Examples of heterocyclic rings are pyridine rings and pyrimidine rings. From the perspective of compatibility with the binder, aromatic rings are desirable, and benzene and naphthalene rings are preferred.

At least one carboxyl group is contained per molecule of compound B, but two or more may be present. From the perspective of dispersibility, equal to or fewer than two carboxyl groups are contained in compound B per molecule. When two or more carboxyl groups are contained per molecule, it is preferable for the carboxyl groups to be present on adjacent carbons.

Specific examples of compound B are given below. However, the present invention is not limited to the specific examples given below.

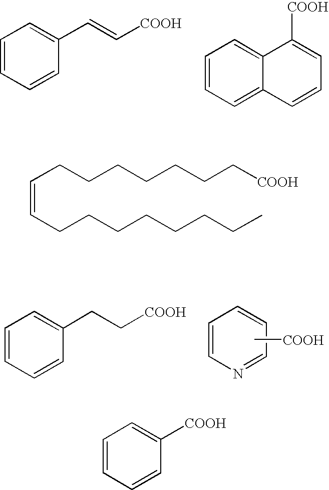

The quantity of compound A employed can be suitably set for the powder (ferromagnetic powder or nonmagnetic powder) in the magnetic layer or nonmagnetic layer. For example, 0.1 to 10 weight parts of compound A can be employed per 100 weight parts of powder such as magnetic powder, with 2 to 8 weight parts being desirable. When compounds A and B are employed in combination, from the perspective of the powder surface-modifying effect, the ratio (by weight) of compound A/compound B is desirably from 10/1 to 1/10, preferably from 2/1 to 1/7. The combined quantity of compounds A and B can be suitably set. For example, 0.1 to 10 weight parts can be employed, with 2 to 8 weight parts being desirable, per 100 weight parts of powder such as magnetic powder.

Compound A, or the combination of compounds A and B, can increase the dispersibility of powder in the coating material containing the powder and binder by modifying the surface of a powder such as a magnetic powder or nonmagnetic powder. Accordingly, these compounds are desirably employed as dispersing agents in the various coating materials that contain powder and binder, are preferably employed as dispersing agents in magnetic coating materials containing magnetic powder and binder and in nonmagnetic coating materials containing nonmagnetic powder and binder, and are more preferably employed as dispersing agent in the magnetic layer-forming coating liquids and nonmagnetic layer-forming coating liquids of magnetic recording media of which increased coating smoothness may be required through an increase in the degree of dispersion of the powders.

The magnetic recording medium according to one embodiment of the present invention can be manufactured by preparing a magnetic layer-forming coating liquid by mixing ferromagnetic powder, binder, and compound A (and optionally compound B), and coating and drying the magnetic layer-forming coating liquid that has been prepared on a nonmagnetic support to form a magnetic layer.

The magnetic recording medium according to another form of the present invention can be manufactured by preparing a nonmagnetic layer-forming coating liquid by mixing a nonmagnetic powder, binder, and compound A (and optionally compound B), and coating and drying the nonmagnetic layer-forming coating liquid that has been prepared on a nonmagnetic support to form a nonmagnetic layer.

Methods of manufacturing the magnetic recording medium of the present invention will be described more specifically below.

### Preparation of Magnetic Layer-Forming Coating Liquid

A magnetic layer-forming coating liquid (also referred to as “magnetic layer coating liquid”) can be obtained by mixing compound A, optionally compound B, ferromagnetic powder, binder, and any optionally employed additives. Specifically, it can be obtained by the common method of preparing a magnetic layer coating liquid. The preparation process consists of, for example, a kneading step, dispersing step, and mixing steps conducted as needed before and after these steps. Each individual step can be divided into two or more stages. The kneading step is desirably conducted in an open kneader, continuous kneader, pressure kneader, extruder, or some other device generating a powerful kneading force. Details of these kneading processes are described in Japanese Unexamined Patent Publication (KOKAI) Heisei Nos. 1-106338 and 1-79274, which are expressly incorporated herein by reference in their entirety. Glass beads can be employed to disperse the magnetic layer-forming coating liquid. High specific gravity dispersion media in the form of zirconia beads, titania beads, and steel balls are suitable as such glass beads. The particle diameters and fill rates of these dispersion media can be optimized for use. A known disperser can be employed.

To effectively achieve the addition effects of compounds A and B, it is desirably for the compounds to be brought into contact with the surface of the magnetic powder during or before the stage in which the ferromagnetic powder is brought into contact with the binder. This is because the compounds contact and react with the surface of the ferromagnetic powder, producing their effects, thereby preventing the binder from contacting the surface of the ferromagnetic powder before these compounds have come into contact with the surface of the ferromagnetic powder. Accordingly, the magnetic layer-forming coating liquid is desirably prepared by simultaneously mixing the ferromagnetic powder, binder, and above compounds, or by mixing the ferromagnetic powder and the above compounds to obtain a mixture, to which the binder is then mixed. Specifically, the compounds are desirably mixed by the following methods.
(1) Dry dispersing the ferromagnetic powder and the above compounds in advance for about 15 to 30 minutes, and then adding an organic solvent. The binder can be added simultaneously with the dispersion, or added after the dispersion.
(2) Dispersing the ferromagnetic powder and the compounds in an organic solvent for about 15 to 30 minutes and drying them. The dry mixture is then suitably pulverized and added to an organic solvent. The binder can be simultaneously added to the mixture, or added after the mixture.
(3) Dispersing the ferromagnetic powder and the compounds for about 15 to 30 minutes in an organic solvent, and then adding the binder.
(4) Simultaneously adding the ferromagnetic powder, the compounds, and binder to the organic solvent and dispersing them.

Compounds A and B can be added simultaneously with the ferromagnetic powder, or can be added sequentially. For example, the following are possible: (i) the ferromagnetic powder and compound A are first mixed, after which compound B is added; (ii) the ferromagnetic powder and compound B are first mixed, after which compound A is added; and (iii) compounds A and B are simultaneously added. Any mixing method may be employed in the present invention. From the perspective of enhancing dispersion, (ii) or (iii) is desirable, and (ii) is preferred.

### Ferromagnetic Powder

Ferromagnetic powders that can generally be incorporated into the magnetic layer-forming coating liquid of a magnetic recording medium can be employed. To achieve a good surface-modifying effect with the compounds, hexagonal ferrite powders and ferromagnetic metal powders are desirable as the ferromagnetic powder.

Hexagonal ferrite powders and ferromagnetic metal powders will be described below in greater detail.

### (i) Hexagonal Ferrite Powder

Examples of hexagonal ferrite powders are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite powder in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed.

As the hexagonal ferrite powder, those having an average plate diameter ranging from 10 to 50 nm are desirably employed. The average plate diameter preferably ranges from 15 to 40 nm, more preferably 15 to 30 nm. The hexagonal ferrite powder with the above size is suitable for use in magnetic recording media for high-density recording. According to the present invention, the dispersibility of microgranular hexagonal ferrite powders such as those with the above-described average plate diameter can be improved.

An average plate ratio [arithmetic average of (plate diameter/plate thickness)] preferably ranges from 1 to 15, more preferably 1 to 7. When the average plate diameter ranges from 1 to 15, adequate orientation can be achieved while maintaining high filling property, as well as increased noise due to stacking between particles can be suppressed. The specific surface area by BET method (S_{BET}) within the above particle size range is preferably equal to or higher than 40 m²/g, more preferably 40 to 200 m²/g, and particularly preferably, 60 to 100 m²/g.

Narrow distributions of particle plate diameter and plate thickness of the hexagonal ferrite powder are normally good. About 500 particles can be randomly measured in a transmission electron microscope (TEM) photograph of particles to measure the particle plate diameter and plate thickness, as set forth above. The distributions of particle plate diameter and plate thickness are often not a normal distribution. However, when expressed as the standard deviation to the average size, σ/average size may be 0.1 to 1.0. The particle producing reaction system is rendered as uniform as possible and the particles produced are subjected to a distribution-enhancing treatment to achieve a narrow particle size distribution. For example, methods such as selectively dissolving ultrafine particles in an acid solution by dissolution are known. The pH of the hexagonal ferrite powder is normally about 4 to 12 and usually optimum for the dispersion medium and polymer. From the perspective of the chemical stability and storage properties in the medium, a pH of about 6 to 11 can be selected. Moisture contained in the hexagonal ferrite powder also affects dispersion. The moisture content is usually optimum for the dispersion medium and polymer, normally within a range of 0.01 to 2.0.

Methods of manufacturing the hexagonal ferrite powder include: (1) a vitrified crystallization method consisting of mixing into a desired ferrite composition barium oxide, iron oxide, and a metal oxide substituting for iron with a glass forming substance such as boron oxide; melting the mixture; rapidly cooling the mixture to obtain an amorphous material; reheating the amorphous material; and refining and comminuting the product to obtain a barium ferrite crystal powder; (2) a hydrothermal reaction method consisting of neutralizing a barium ferrite composition metal salt solution with an alkali; removing the by-product; heating the liquid phase to equal to or greater than 100° C.; and washing, drying, and comminuting the product to obtain barium ferrite crystal powder; and (3) a coprecipitation method consisting of neutralizing a barium ferrite composition metal salt solution with an alkali; removing the by-product; drying the product and processing it at equal to or less than 1,100° C.; and comminuting the product to obtain barium ferrite crystal powder. The hexagonal ferrite powder employed in the present invention can be manufactured by any manufacturing method. As needed, the hexagonal ferrite powder can be surface treated with Al, Si, P, or an oxide thereof. The quantity can be set to 0.1 to 10 weight percent of the hexagonal ferrite powder. When applying a surface treatment, the quantity of a lubricant such as a fatty acid that is adsorbed is desirably not greater than 100 mg/m². The hexagonal ferrite powder will sometimes contain inorganic ions such as soluble Na, Ca, Fe, Ni, or Sr. These are desirably substantially not present, but seldom affect characteristics at equal to or less than 200 ppm.

(ii) Ferromagnetic Metal Powder

The ferromagnetic metal powder employed is not specifically limited, but preferably a ferromagnetic metal power comprised primarily of α-Fe. In addition to prescribed atoms, the following atoms can be contained in the ferromagnetic metal powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B and the like. Particularly, incorporation of at least one of the following in addition to α-Fe is desirable: Al, Si, Ca, Y, Ba, La, Nd, Co, Ni, and B. Incorporation of at least one selected from the group consisting of Co, Y and Al is particularly preferred. The Co content preferably ranges from 0 to 40 atom percent, more preferably from 15 to 35 atom percent, further preferably from 20 to 35 atom percent with respect to Fe. The content of Y preferably ranges from 1.5 to 12 atom percent, more preferably from 3 to 10 atom percent, further preferably from 4 to 9 atom percent with respect to Fe. The Al content preferably ranges from 1.5 to 12 atom percent, more preferably from 3 to 10 atom percent, further preferably from 4 to 9 atom percent with respect to Fe.

The ferromagnetic metal powder may contain a small quantity of hydroxide or oxide. Ferromagnetic metal powders obtained by known manufacturing methods may be employed. The following are examples of methods of manufacturing ferromagnetic metal powders: methods of reduction with compound organic acid salts (chiefly oxalates) and reducing gases such as hydrogen; methods of reducing iron oxide with a reducing gas such as hydrogen to obtain Fe or Fe—Co particles or the like; methods of thermal decomposition of metal carbonyl compounds; methods of reduction by addition of a reducing agent such as sodium boron hydride, hypophosphite, or hydrazine to an aqueous solution of ferromagnetic metal; and methods of obtaining powder by vaporizing a metal in a low-pressure inert gas. Any one from among the known method of slow oxidation, that is, immersing the ferromagnetic metal powder thus obtained in an organic solvent and drying it; the method of immersing the ferromagnetic metal powder in an organic solvent, feeding in an oxygen-containing gas to form a surface oxide film, and then conducting drying; and the method of adjusting the partial pressures of oxygen gas and an inert gas without employing an organic solvent to form a surface oxide film, may be employed.

The specific surface area by BET method of the ferromagnetic metal powder employed is preferably 45 to 100 m²/g, more preferably 50 to 80 m²/g. At 45 m²/g and above, low noise can be achieved. At 100 m²/g and below, the magnetic layer with good surface properties can be formed. The crystallite size of the ferromagnetic metal powder is preferably 40 to 180 Angstroms, more preferably 40 to 150 Angstroms, and still more preferably, 40 to 110 Angstroms. The average major axis length (average particle size) of the ferromagnetic metal powder preferably ranges from 10 to 50 nm, more preferably 10 to 40 nm, and further preferably 15 to 30 nm. According to the present invention, the dispersibility of microgranular ferromagnetic metal powders such as those with the above-described average major axis length can be improved. The acicular ratio of the ferromagnetic metal powder is preferably equal to or greater than 3 and equal to or less than 15, more preferably equal to or greater than 3 and equal to or less than 12.

The moisture content of the ferromagnetic metal powder preferably ranges from 0.01 to 2 weight percent. The moisture content of the ferromagnetic metal powder is desirably optimized based on the type of binder. The pH of the ferromagnetic metal powder is desirably optimized depending on what is combined with the binder. A range of 4 to 12 can be established, with 6 to 10 being preferred. As needed, the ferromagnetic metal powder can be surface treated with Al, Si, P, or an oxide thereof. The quantity can be set to 0.1 to 10 weight percent of the ferromagnetic metal powder. When applying a surface treatment, the quantity of a lubricant such as a fatty acid that is adsorbed is desirably not greater than 100 mg/m². The ferromagnetic metal powder will sometimes contain inorganic ions such as soluble Na, Ca, Fe, Ni, or Sr. These are desirably substantially not present, but seldom affect characteristics at equal to or less than 200 ppm. The ferromagnetic metal powder employed in the present invention desirably has few voids; the level is preferably equal to or less than 20 volume percent, more preferably equal to or less than 5 volume percent. As stated above, so long as the particle size characteristics are satisfied, the ferromagnetic metal powder may be acicular, rice grain-shaped, or spindle-shaped.

### Binder

Conventionally known thermoplastic resins, thermosetting resins, reactive resins and mixtures thereof may be employed as binders used. The thermoplastic resins suitable for use have a glass transition temperature of −100 to 150° C., a number average molecular weight of 1,000 to 200,000, preferably from 10,000 to 100,000, and have a degree of polymerization of about 50 to 1,000.

Examples thereof are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Further, examples of thermosetting resins and reactive resins are phenol resins, epoxy resins, polyurethane cured resins, urea resins, melamine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in Handbook of Plastics published by Asakura Shoten, which is expressly incorporated herein by reference in its entirety. It is also possible to employ known electron beam-cured resins. Examples and manufacturing methods of such resins are described in Japanese Unexamined Patent Publication (KOKAI) Showa No. 62-256219, which is expressly incorporated herein by reference in its entirety. The above-listed resins may be used singly or in combination. Preferred resins are polyurethane resin, combinations of polyurethane resin and at least one member selected from the group consisting of vinyl chloride resin, vinyl chloride—vinyl acetate copolymers, vinyl chloride—vinyl acetate—vinyl alcohol copolymers, and vinyl chloride—vinyl acetate—maleic anhydride copolymers, as well as combinations of the same with polyisocyanate. Resins suitable for use as binder can be synthesized by known methods, and may be commercially available.

Known polyurethane resins may be employed, such as polyester polyurethane, polyether polyurethane, polyether polyester polyurethane, polycarbonate polyurethane, polyester polycarbonate polyurethane, and polycaprolactone polyurethane. A binder obtained by incorporating as needed one or more polar groups selected from among —COOM, —SO₃M, —OSO₃M, —P═O(OM)₂, and —O—P═O(OM)₂ (where M denotes a hydrogen atom or an alkali metal base), —OH, —NR₂, —N⁺R₃ (where R denotes a hydrocarbon group), epoxy group, —SH, and —CN into any of the above-listed binders by copolymerization or addition reaction to improve dispersion properties and durability is desirably employed. The quantity of such a polar group ranges, for example, from 10⁻¹ to 10⁻⁸ mol/g, preferably from 10⁻² to 10⁻⁶ mol/g. From the perspective of compatibility with binder, compounds A and B are preferably employed together with binder comprising a sulfonic acid (salt) group. In the present invention, the term “sulfonic acid (salt) group” includes sulfonic acid group (—SO₃H) and sulfonic acid salt group (—SO₃M′ where M′ denotes an alkali metal atom such as Li, Na, K and the like),

The quantity of binder added to the magnetic layer coating liquid ranges from, for example, 5 to 50 weight percent, preferably from 10 to 30 weight percent, relative to the weight of the ferromagnetic powder. When employing vinyl chloride resin, the quantity of binder added is preferably from 5 to 30 weight percent; when employing polyurethane resin, from 2 to 20 weight percent; and when employing polyisocyanate, from 2 to 20 weight percent. They may be employed in combination. However, for example, when head corrosion occurs due to the release of trace amounts of chlorine, polyurethane alone or just polyurethane and isocyanate may be employed.

Examples of polyisocyanates are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. They are commercially available, and can be used in each layer singly or in combinations of two or more by exploiting differences in curing reactivity.

As set forth above, when compound A contains two or more hydroxyl groups and/or one amino group per molecule, it can form urethane bonds by reacting with an isocyanate compound. An example of an isocyanate compound that is desirably employed in combination with compound A from the perspective of forming urethane bonds and increasing the coating strength is a bifunctional or higher polyfunctional isocyanate compound. Specific examples are as set forth above. Using an isocyanate compound as a binder component of the nonmagnetic layer-forming coating liquid described further below makes it possible to achieve this effect when the isocyanate compound in the lower layer migrates to the magnetic layer positioned above, reacting with compound A that has adsorbed to the surface of the ferromagnetic powder.

In addition to the above compounds, ferromagnetic powder, and binder, additives can also be added to the magnetic layer-forming coating liquid. Examples of these additives are the abrasives, lubricants, antifungal agents, antistatic agents, oxidation inhibitors, solvents, and carbon black that are generally employed in the magnetic layer-forming coating liquid of magnetic recording media.

A known organic solvent can be employed. Examples of organic solvents are, in any ratio: ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutylalcohol, isopropylalcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylenechlorhydrin, and dichlorobenzene; N,N-dimethylformamide; and hexane.

These organic solvents need not be 100 percent pure and may contain impurities such as isomers, unreacted materials, by-products, decomposition products, oxides and moisture in addition to the main components. The content of these impurities is preferably equal to or less than 30 weight percent, more preferably equal to or less than 10 weight percent. To improve dispersion properties, a solvent having a somewhat strong polarity is desirable. It is desirable that solvents having a dielectric constant equal to or higher than 15 are comprised equal to or higher than 50 weight percent of the solvent composition. Further, the dissolution parameter is desirably 8 to 11.

The magnetic layer-forming coating liquid that has been prepared can be coated and dried, either directly or over another layer, on the nonmagnetic support to form a magnetic layer. Prior to coating the magnetic layer-forming coating liquid, a nonmagnetic layer-forming coating liquid (also referred to as “nonmagnetic layer coating liquid”) containing nonmagnetic powder and binder can be coated on the nonmagnetic support. Thus, a magnetic recording medium can be obtained that is sequentially comprised a nonmagnetic layer and a magnetic layer on a nonmagnetic support.

The magnetic recording medium of the present invention can be manufactured using a magnetic layer-forming coating liquid, and/or a nonmagnetic layer-forming coating liquid, containing the above compounds. The compounds can be added to the nonmagnetic layer-forming coating liquid to modify the surface of the nonmagnetic powder, increase adsorption of the binder to the nonmagnetic powder in the nonmagnetic layer, and increase the dispersibility of the nonmagnetic powder.

The nonmagnetic layer-forming coating liquid will be described in greater detail below.

### Preparation of the Nonmagnetic Layer-Forming Coating Liquid

The nonmagnetic layer-forming coating liquid can be obtained by mixing the nonmagnetic powder, binder, and optionally employed additives. Adding the above compounds can modify the surface of the nonmagnetic powder, increase adsorption of the binder to the nonmagnetic powder in the nonmagnetic layer, and increase the dispersibility of the nonmagnetic powder.

The nonmagnetic powder may be either an organic or inorganic substance. Carbon black and the like may also be employed. Examples of inorganic substances are metals, metal oxides, metal carbonates, metal sulfates, metal nitrides, metal carbides, and metal sulfides. From the perspective of the surface-modifying effect, nonmagnetic metal powders are suitably employed.

Specifically, titanium oxides such as titanium dioxide, cerium oxide, tin oxide, tungsten oxide, ZnO, ZrO₂, SiO₂, Cr₂O₃, α-alumina with an a-conversion rate of 90 to 100 percent, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide may be employed singly or in combinations of two or more. α-iron oxide and titanium oxide are preferred.

The nonmagnetic powder may be acicular, spherical, polyhedral, or plate-shaped. The crystallite size of the nonmagnetic powder preferably ranges from 4 nm to 500 nm, more preferably from 40 to 100 nm. The average particle diameter of the nonmagnetic powder preferably ranges from 5 nm to 500 nm, more preferably from 10 to 200 nm. The nonmagnetic powder with the above size is suitable for use in the nonmagnetic layer coating liquid for the magnetic recording medium for high-density recording. With compound A and B described above, nonmagnetic powders with the above size can be dispersed well in a nonmagnetic coating material.

The specific surface area of the nonmagnetic powder preferably ranges from 1 to 150 m²/g, more preferably from 20 to 120 m²/g, and further preferably from 50 to 100 m²/g. Within the specific surface area ranging from 1 to 150 m²/g, a nonmagnetic layer with suitable surface roughness can be achieved and dispersion of the nonmagnetic powder is possible with the desired quantity of binder; the above range is preferred. Oil absorption capacity using dibutyl phthalate (DBP) of the nonmagnetic powder preferably ranges from 5 to 100 mL/100 g, more preferably from 10 to 80 mL/100 g, and further preferably from 20 to 60 mL/100 g. The specific gravity preferably ranges from 1 to 12, more preferably from 3 to 6. The tap density preferably ranges from 0.05 to 2 g/mL, more preferably from 0.2 to 1.5 g/mL. A tap density falling within a range of 0.05 to 2 g/mL can reduce the amount of scattering particles, thereby facilitating handling, and tends to prevent solidification to the device. The pH of the nonmagnetic powder preferably ranges from 2 to 11, more preferably from 6 to 9. When the pH falls within a range of 2 to 11, the coefficient of friction does not become high at high temperature or high humidity, or due to the freeing of fatty acids. The moisture content of the nonmagnetic powder preferably ranges from 0.1 to 5 weight percent, more preferably from 0.2 to 3 weight percent, and further preferably from 0.3 to 1.5 weight percent. A moisture content falling within a range of 0.1 to 5 weight percent is desirable because it can produce good dispersion and yield a stable coating viscosity following dispersion. An ignition loss of equal to or less than 20 weight percent is desirable and nonmagnetic powders with low ignition losses are desirable.

When the nonmagnetic powder is an inorganic powder, the Mohs' hardness is preferably 4 to 10. Durability can be ensured if the Mohs' hardness ranges from 4 to 10. The heat of wetting in 25° C. water of the nonmagnetic powder is preferably within a range of 200 to 600 mJ/cm² (approximately 200 to 600 erg/cm²). A solvent with a heat of wetting within this range may also be employed. The quantity of water molecules on the surface at 100 to 400° C. suitably ranges from 1 to 10 pieces per 100 Angstroms. The pH of the isoelectric point in water preferably ranges from 3 to 9. The surface of these nonmagnetic powders preferably contains Al₂O₃, SiO₂, TiO₂, ZrO₂, SnO₂, Sb₂O₃, and ZnO by conducting surface treatment. The surface-treating agents of preference with regard to dispersibility are Al₂O₃, SiO₂, TiO₂, and ZrO₂, and Al₂O₃, SiO₂ and ZrO₂ are further preferable. They may be employed singly or in combination. Depending on the objective, a surface-treatment coating layer with a coprecipitated material may also be employed, the method which comprises a first alumina coating and a second silica coating thereover or the reverse method thereof may also be adopted. Depending on the objective, the surface-treatment coating layer may be a porous layer, with homogeneity and density being generally desirable.

Specific examples of nonmagnetic powders are: Nanotite from Showa Denko K. K.; HIT-100 and ZA-G1 from Sumitomo Chemical Co., Ltd.; DPN-250, DPN-250BX, DPN-245, DPN-270BX, DPN-550BX and DPN-550RX from Toda Kogyo Corp.; titanium oxide TTO-51B, TTO-55A, TTO-55B, TTO-55C, TTO-55S, TTO-55D, SN-100, MJ-7, α-iron oxide E270, E271 and E300 from Ishihara Sangyo Co., Ltd.; STT-4D, STT-30D, STT-30 and STT-65C from Titan Kogyo K. K.; MT-100S, MT-100T, MT-150W, MT-500B, T-600B, T-100F and T-500HD from Tayca Corporation; FINEX-25, BF-1, BF-10, BF-20 and ST-M from Sakai Chemical Industry Co., Ltd.; DEFIC-Y and DEFIC-R from Dowa Mining Co., Ltd.; AS2BM and TiO2P25 from Nippon Aerogil; 100A and 500A from Ube Industries, Ltd.; Y-LOP from Titan Kogyo K. K.; and sintered products of the same. Particular preferable nonmagnetic powders are titanium dioxide and α-iron oxide.

Details of the binder that is added to the nonmagnetic layer-forming coating liquid are identical to those of the binder contained in the magnetic layer-forming coating liquid described above. The nonmagnetic layer-forming coating liquid may further comprise the various additives and solvents employed in magnetic recording media. Details of individual components in the nonmagnetic layer-forming coating liquid, methods of mixing these components, the quantities in which they are added, and the like are as set forth above with regard to the magnetic layer-forming coating liquid.

### Nonmagnetic Layer

Known films of the following may be employed as the nonmagnetic support in the present invention: polyethylene terephthalate, polyethylene naphthalate, other polyesters, polyolefins, cellulose triacetate, polycarbonate, polyamides, polyimides, polyamidoimides, polysulfones, aromatic polyamides, polybenzooxazoles, and the like. Supports having a glass transition temperature of equal to or higher than 100° C. are preferably employed. The use of polyethylene naphthalate, aramid, or some other high-strength support is particularly desirable. As needed, layered supports such as disclosed in Japanese Unexamined Patent Publication (KOKAI) Heisei No. 3-224127, which is expressly incorporated herein by reference in its entirety, may be employed to vary the surface roughness of the magnetic surface and support surface. These supports may be subjected beforehand to corona discharge treatment, plasma treatment, adhesion enhancing treatment, heat treatment, dust removal, and the like.

The center surface average surface roughness (Ra) of the nonmagnetic support as measured with an optical interferotype surface roughness meter HD-2000 made by WYKO is preferably equal to or less than 8.0 nm, more preferably equal to or less than 4.0 nm, further preferably equal to or less than 2.0 nm. Not only does such a support desirably have a low center surface average surface roughness (Ra), but there are also desirably no large protrusions equal to or higher than 0.5 μm. The surface roughness shape may be freely controlled through the size and quantity of filler added to the support as needed. Examples of such fillers are oxides and carbonates of elements such as Ca, Si, and Ti, and organic powders such as acrylic-based one. The support desirably has a maximum height Rₘₐₓ equal to or less than 1 μm, a ten-point average roughness R_{Z} equal to or less than 0.5 μm, a center surface peak height R_{P} equal to or less than 0.5 μm, a center surface valley depth R_{V} equal to or less than 0.5 μm, a center-surface surface area percentage Sr of 10 percent to 90 percent, and an average wavelength λₐ of 5 to 300 μm. To achieve desired electromagnetic characteristics and durability, the surface protrusion distribution of the support can be freely controlled with fillers. It is possible to control within a range from 0 to 2,000 protrusions of 0.01 to 1 μm in size per 0.1 mm².

The F-5 value of the nonmagnetic support suitable for use in the present invention desirably ranges from 5 to 50 kg/mm², approximately 49 to 490 MPa. The thermal shrinkage rate of the support after 30 min at 100° C. is preferably equal to or less than 3 percent, more preferably equal to or less than 1.5 percent. The thermal shrinkage rate after 30 min at 80° C. is preferably equal to or less than 1 percent, more preferably equal to or less than 0.5 percent. The breaking strength of the nonmagnetic support preferably ranges from 5 to 100 kg/mm², approximately 49 to 980 MPa. The modulus of elasticity preferably ranges from 100 to 2,000 kg/mm², approximately 0.98 to 19.6 GPa. The thermal expansion coefficient preferably ranges from 10⁻⁴ to 10⁻⁸/° C., more preferably from 10⁻⁵ to 10⁻⁶/° C. The moisture expansion coefficient is preferably equal to or less than 10⁻⁴/RH percent, more preferably equal to or less than 10⁻⁵/RH percent. These thermal characteristics, dimensional characteristics, and mechanical strength characteristics are desirably nearly equal, with a difference equal to less than 10 percent, in all in-plane directions in the support.

An undercoating layer can be provided in the magnetic recording medium of the present invention. Providing an undercoating layer can enhance adhesive strength between the support and the magnetic layer or nonmagnetic layer. For example, a polyester resin that is soluble in solvent can be employed as the undercoating layer to enhance adhesion. As described below, a smoothing layer can be provided as an undercoating layer.

### Layer Structure

In the magnetic recording medium according to the present invention, the thickness of the nonmagnetic support preferably ranges from 3 to 80 μm, more preferably 3 to 50 μm, and further preferably, 3 to 10 μm. When an undercoating layer is provided between the nonmagnetic support and the nonmagnetic layer or the magnetic layer, the thickness of the undercoating layer is, for example, from 0.01 to 0.8 μm, preferably from 0.02 to 0.6 μm.

An intermediate layer can be provided between the support and the nonmagnetic layer or the magnetic layer and/or between the support and the backcoat layer to improve smoothness. For example, the intermediate layer can be formed by coating and drying a coating liquid comprising a polymer on the surface of the nonmagnetic support, or by coating a coating liquid comprising a compound (radiation-curable compound) comprising intramolecular radiation-curable functional groups and then irradiating it with radiation to cure the coating liquid.

A radiation-curable compound having a number average molecular weight ranging from 200 to 2,000 is desirably employed. When the molecular weight is within the above range, the relatively low molecular weight can facilitate coating flow during the calendering step, increasing moldability and permitting the formation of a smooth coating.

A radiation-curable compound in the form of a bifunctional acrylate compound with the molecular weight of 200 to 2,000 is desirable. Bisphenol A, bisphenol F, hydrogenated bisphenol A, hydrogenated bisphenol F, and compounds obtained by adding acrylic acid or methacrylic acid to alkylene oxide adducts of these compounds are preferred.

The radiation-curable compound can be used in combination with a polymeric binder. Examples of the binder employed in combination are conventionally known thermoplastic resins, thermosetting resins, reactive resins, and mixtures thereof. When the radiation employed is UV radiation, a polymerization initiator is desirably employed in combination. A known photoradical polymerization initiator, photocationic polymerization initiator, photoamine generator, or the like can be employed as the polymerization initiator.

A radiation-curable compound can also be employed in the nonmagnetic layer.

The thickness of the magnetic layer can be optimized based on the saturation magnetization of the head employed, the length of the head gap, and the recording signal band, and is normally 10 to 150 nm, preferably 20 to 120 nm, more preferably 30 to 100 nm, and further preferably 30 to 80 nm. The thickness variation (σ/δ) in the magnetic layer is preferably within ±50 percent, more preferably within ±30 percent. At least one magnetic layer is sufficient. The magnetic layer may be divided into two or more layers having different magnetic characteristics, and a known configuration relating to multilayered magnetic layer may be applied.

The thickness of the nonmagnetic layer ranges from, for example, 0.1 to 3.0 μm, preferably 0.2 to 2.0 μm, and more preferably 0.3 to 1.5 μm. The nonmagnetic layer is effective so long as it is substantially nonmagnetic in the magnetic recording medium of the present invention. For example, it exhibits the effect of the present invention even when it comprises impurities or trace amounts of magnetic material that have been intentionally incorporated, and can be viewed as substantially having the same configuration as the magnetic recording medium of the present invention. The term “substantially nonmagnetic” is used to mean having a residual magnetic flux density in the nonmagnetic layer of equal to or less than 10 mT, or a coercivity of equal to or less than 7.96 kA/m (100 Oe), it being preferable not to have a residual magnetic flux density or coercivity at all.

### Backcoat Layer

The magnetic recording medium of the present invention can comprise a backcoat layer on the opposite surface of the nonmagnetic support from the surface on which the magnetic layer is present. The backcoat layer desirably comprises carbon black and inorganic powder. Compound A (and optionally compound B) described above can also be added to the backcoat layer. Such addition can increase adsorption of the powder and binder in the backcoat layer and thus increase the dispersibility of the powder. Details of the quantity and method of addition of the above compounds that are added in such cases are as set forth above for the magnetic layer coating liquid.

The compositions of the magnetic layer and nonmagnetic layer can be applied to the binder and various additives of the backcoat layer. In particular, the composition of the nonmagnetic layer can be applied. The thickness of the backcoat layer is desirably equal to or less than 0.9 μm, preferably 0.1 to 0.7 μm.

The method of preparing the magnetic layer coating liquid is as set forth above. The coating liquids for forming other layers, such as the nonmagnetic layer and the backcoat layer, can also be prepared by the same method.

In the process of manufacturing the magnetic recording medium, for example, the nonmagnetic layer can be formed by coating a nonmagnetic layer coating liquid to a prescribed film thickness on the surface of a nonmagnetic support while the nonmagnetic support is running, and then the magnetic layer can be formed by coating a magnetic layer coating liquid to a prescribed film thickness thereover. Multiple magnetic layer coating liquids can be successively or simultaneously coated in a multilayer coating, and the nonmagnetic layer coating liquid and the magnetic layer coating liquid can be successively or simultaneously applied in a multilayer coating. Coating machines suitable for use in coating the magnetic layer and nonmagnetic layer coating liquids are air doctor coaters, blade coaters, rod coaters, extrusion coaters, air knife coaters, squeeze coaters, immersion coaters, reverse roll coaters, transfer roll coaters, gravure coaters, kiss coaters, cast coaters, spray coaters, spin coaters, and the like. For example, “Recent Coating Techniques” (May 31, 1983), issued by the Sogo Gijutsu Center K.K., which is expressly incorporated herein by reference in its entirety, may be referred to in this regard.

For a magnetic tape, the coating layer that is formed by applying the magnetic layer coating liquid can be magnetic field orientation processed using cobalt magnets or solenoids on the ferromagnetic powder contained in the coating layer. In the case of a disk, adequately isotropic orientation can sometimes be achieved with no orientation without using an orienting device. However, the diagonal arrangement of cobalt magnets in alternating fashion or the use of a known random orienting device such as a solenoid to apply an a.c. magnetic field is desirable. In the case of a ferromagnetic metal powder, the term “isotropic orientation” generally means randomness in the two in-plane dimensions, but can also be three-dimensional randomness when the vertical component is included. A known method such as magnets with opposite poles positioned opposite each other can also be employed to impart isotropic magnetic characteristics in a circumferential direction by effecting vertical orientation. When conducting particularly high-density recording, vertical orientation is desirable. Spin coating can also be employed to effect circumferential orientation.

The drying position of the coating is desirably controlled by controlling the temperature and flow rate of drying air, and coating speed. A coating speed of 20 m/min to 1,000 m/min and a dry air temperature of equal to or higher than 60° C. are desirable. Suitable predrying can be conducted prior to entry into the magnet zone.

The coated stock material obtained in this manner is normally temporarily rolled on a pickup roll, and after a period, wound off the pickup roll and subjected to calendering.

In calendering, super calender rolls or the like can be employed. Calendering can enhance the smoothness of the surface, eliminate voids produced by removing the solvent during drying, and increase the fill rate of ferromagnetic powder in the magnetic layer, yielding a magnetic recording medium with good electromagnetic characteristics. The calendering step is desirably conducted by varying the calendering conditions based on the smoothness of the surface of the coated stock material.

The surface smoothness of the coated stock material can be controlled by means of the calender roll temperature, calender roll speed, and calender roll tension. The calender roll pressure and calender roll temperature are desirably controlled by taking into account the characteristics of the particulate medium. Lowering the calender roll pressure or calender roll temperature can decrease the surface smoothness of the final product. Conversely, raising the calender roll pressure or calender roll temperature can increase the surface smoothness of the final product.

Additionally, following the calendering step, the magnetic recording medium can be thermally processed to cause thermosetting to proceed. Such thermal processing can be suitably determined based on the blending formula of the magnetic layer coating liquid. An example is 35 to 100° C., desirably 50 to 80° C. The thermal processing period is, for example, 12 to 72 hours, desirably 24 to 48 hours.

Calender rolls made of epoxy, polyimide, polyamide, polyamideimide, and other heat-resistant plastic rolls can be employed. Processing can also be conducted with metal rolls.

Among the calendering conditions, the calender roll temperature, for example, falls within a range of 60 to 100° C., desirably a range of 70 to 100° C., and preferably a range of 80 to 100° C. The pressure, for example, falls within a range of 100 to 500 kg/cm (approximately 98 to 490 kN/m), preferably a range of 200 to 450 kg/cm (approximately 196 to 441 kN/m), and preferably a range of 300 to 400 kg/cm (approximately 294 to 392 kN/m). To increase the smoothness of the magnetic layer surface, the nonmagnetic layer surface can also be calendered. Calendering of the nonmagnetic layer is also desirably conducted under the above conditions.

The magnetic recording medium that is obtained can be cut to desired size with a cutter or the like for use. The cutter is not specifically limited, but desirably comprises multiple sets of a rotating upper blade (male blade) and lower blade (female blade). The slitting speed, engaging depth, peripheral speed ratio of the upper blade (male blade) and lower blade (female blade) (upper blade peripheral speed/lower blade peripheral speed), period of continuous use of slitting blade, and the like can be suitably selected.

Physical properties of the magnetic recording medium of the present invention will be described below.

### Physical Properties

The magnetic layer desirably has a surface roughness, as a centerline average roughness, ranging from 1.0 to 3.0 nm. The magnetic layer having a centerline average roughness of equal to or lower than 3.0 nm can achieve good electromagnetic characteristics. With a centerline average roughness of equal to or greater than 1.0 nm, stable running can be achieved. The centerline average roughness of the magnetic layer preferably ranges from 1.5 to 3.0 nm, more preferably from 1.5 to 2.5 nm. The magnetic layer having an excellent surface roughness can be formed by using the compounds described above. The surface roughness of the magnetic layer can also be controlled by adjusting dispersion conditions of the magnetic layer coating liquid, calendering conditions, the quantity of fillers in the nonmagnetic support, using an undercoating layer for enhancing smoothness, and the like.

The coercivity (Hc) of the magnetic layer is preferably 143.2 to 318.3 kA/m (approximately 1,800 to 4,000 Oe), more preferably 159.2 to 278.5 kA/m (approximately 2,000 to 3,500 Oe). Narrower coercivity distribution is preferable. The SFD and SFDr are preferably equal to or lower than 0.8, more preferably equal to or lower than 0.5.

The coefficient of friction of the magnetic recording medium of the present invention relative to the head is, for example, equal to or less than 0.50 and preferably equal to or less than 0.3 at temperatures ranging from −10° C. to 40° C. and humidity ranging from 0 percent to 95 percent, the surface resistivity on the magnetic surface preferably ranges from 10⁴ to 10⁸ ohm/sq, and the charge potential preferably ranges from −500 V to +500 V. The modulus of elasticity at 0.5 percent extension of the magnetic layer preferably ranges from 0.98 to 19.6 GPa (approximately 100 to 2,000 kg/mm²) in each in-plane direction. The breaking strength preferably ranges from 98 to 686 MPa (approximately 10 to 70 kg/mm²). The modulus of elasticity of the magnetic recording medium preferably ranges from 0.98 to 14.7 GPa (approximately 100 to 1500 kg/mm²) in each in-plane direction. The residual elongation is preferably equal to or less than 0.5 percent, and the thermal shrinkage rate at all temperatures below 100° C. is preferably equal to or less than 1 percent, more preferably equal to or less than 0.5 percent, and most preferably equal to or less than 0.1 percent.

The glass transition temperature (i.e., the temperature at which the loss elastic modulus of dynamic viscoelasticity peaks as measured at 110 Hz with a dynamic viscoelastometer, such as RHEOVIBRON) of the magnetic layer preferably ranges from 50 to 180° C., and that of the nonmagnetic layer preferably ranges from 0 to 180° C. The loss elastic modulus preferably falls within a range of 1×10⁷ to 8×10⁸ Pa (approximately 1×10⁸ to 8×10⁹ dyne/cm²) and the loss tangent is preferably equal to or less than 0.2. Adhesion failure tends to occur when the loss tangent becomes excessively large. These thermal characteristics and mechanical characteristics are desirably nearly identical, varying by equal to or less than 10 percent, in each in-plane direction of the medium.

The residual solvent contained in the magnetic layer is preferably equal to or less than 100 mg/m² and more preferably equal to or less than 10 mg/m². The void ratio in the coated layers, including both the nonmagnetic layer and the magnetic layer, is preferably equal to or less than 40 volume percent, more preferably equal to or less than 30 volume percent. Although a low void ratio is preferable for attaining high output, there are some cases in which it is better to ensure a certain level based on the object. For example, in many cases, larger void ratio permits preferred running durability in disk media in which repeat use is important.

Physical properties of the nonmagnetic layer and magnetic layer may be varied based on the objective in the magnetic recording medium of the present invention. For example, the modulus of elasticity of the magnetic layer may be increased to improve running durability while simultaneously employing a lower modulus of elasticity than that of the magnetic layer in the nonmagnetic layer to improve the head contact of the magnetic recording medium.

### Examples

The present invention will be described in detail below based on Examples. However, the present invention is not limited to the examples. The term “parts” given in Examples are weight parts unless specifically stated otherwise.

The details of polymers A to D employed in the following Examples are indicated below.

Polymer A

Polyester polyurethane containing 3.3×10⁻⁴ mole/g of SO₃Na groups.

Adipic acid and neopentyl glycol were contained in the polyester moiety, and 4,4′-diphenylmethane diisocyanate was employed as the urethane component. The weight average molecular weight (Mw) obtained by standard polystyrene conversion using DMF solvent containing 0.3 weight percent of lithium bromide was about 70,000.

Polymer B

Mixed polymer obtained by mixing polyester polyurethane containing 0.6×10⁻⁴ mole/g of SO₃Na groups, vinyl chloride resin (MR-104 made by Zeon Corporation) in a ratio of 1.2:1.

The polyurethane contained adipic acid and neopentyl glycol in the polyester moiety, and 4,4′-diphenylmethane diisocyanate as the urethane component. The weight average molecular weight (Mw) obtained by standard polystyrene conversion using DMF solvent containing 0.3 weight percent of lithium bromide was about 70,000.

Polymer C

Mixed polymer obtained by mixing polyether polyurethane containing 0.6×10⁻⁴ mole/g of SO₃Na groups, vinyl chloride resin (MR-104 made by Zeon Corporation) in a ratio of 1.2:1.

The polyurethane contained a propylene glycol adduct of bisphenol A in the polyester moiety, and 4,4′-diphenylmethane diisocyanate as the urethane component. The weight average molecular weight (Mw) obtained by standard polystyrene conversion using DMF solvent containing 0.3 weight percent of lithium bromide was about 70,000.

Polymer D

Mixed polymer obtained by mixing polyester polyurethane containing 0.7×10⁻⁴ mole/g of SO₃Na groups, vinyl chloride resin (MR-104 made by Zeon Corporation) in a ratio of 1.2:1.

The polyurethane contained phthalic acid and propylene glycol in the polyester moiety and 4,4′-diphenylmethane diisocyanate as the urethane component. The weight average molecular weight (Mw) obtained by standard polystyrene conversion using DMF solvent containing 0.3 weight percent of lithium bromide was about 70,000.

### 1-1. Examples (Employing Compound A Alone) and Comparative Examples Employing Ferromagnetic Hexagonal Ferrite Powder

### Example 1-1

(1) Preparation of Magnetic Coating Material

A 2.2 weight part quantity of the ferromagnetic hexagonal ferrite powder indicated below, 1 weight part of SO₃Na group-containing polymer A (SO₃Na group content: 3.3×10⁻⁴ mole/g), and 0.18 weight part of D-glucono-1,5-lactone were suspended in a solution comprised of 3.3 weight parts of cyclohexanone and 4.9 weight parts of 2-butanone. To the suspension were added 27 weight parts of zirconia beads (made by Nikkato) and the mixture was dispersed for six hours, yielding magnetic coating material 1. To magnetic coating material 1 was added 0.06 weight part of trifunctional isocyanate (Coronate L, made by Nippon Polyurethane Industry Co., Ltd.) and the mixture was dispersed for another 10 minutes, yielding magnetic coating material 2.

### Ferromagnetic Hexagonal Barium Ferrite Powder

Composition excluding oxygen (mole ratio): Ba/Fe/Co/Zn=1/9/0.2/1

Hc: 176 kA/m (2,200 Oe)

Average plate diameter: 25 nm

Average plate ratio: 3

BET specific surface area: 65 m²/g

σs: 49 A·m²/kg (49 emu/g)

pH: 7

(2) Confirmation of Adsorption to Magnetic Powder

The abundance ratio of the binder (polymer A) in magnetic coating material 1 obtained in (1) above on the ferromagnetic powder surface/in the coating material was measured by the following method.

Measurement Method

The powder and solution were centrifugally separated in a small separation-use ultracentrifuge CS150GXL made by Hitachi under conditions of 100,000 rpm for 80 minutes. A 3 mL quantity of supernatant was measured out and weighed. Following drying under conditions of 40° C. for 18 hours, drying was conducted under vacuum conditions at 140° C. for 3 hours. The weight of the dried product was adopted as the nonadsorbed solid component of the binder, and the abundance ratio of the binder on the powder surface/in the coating material was calculated.

(3) Preparation and Evaluation of Magnetic Sheet

Magnetic coating material 2 obtained in (1) above was coated and dried under conditions of 70° C. for 2 days to prepare a magnetic sheet. The gloss of the magnetic sheet prepared was measured with a GK-45D made by Suga Test Instruments Co., Ltd. The higher the gloss value, the better the dispersion of ferromagnetic powder in the magnetic coating material indicated. One weight part of the magnetic sheet obtained was soaked in 100 weight parts of tetrahydrofuran (THF) and extracted under conditions of 70° C. for 3 hours. The THF was dried off in an evaporator, and the concentrated dry solid was weighed. The weight of the concentrated dry solid thus obtained was adopted as the weight of the sol component, and the weight of the gel component was calculated as (weight of magnetic sheet−weight of sol component). Table 1-1 gives the ratio of the gel component/sol component. The larger the gel component, the greater the cured component and the higher the coating strength indicated.

### Example 1-2

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-1.

### Example 1-3

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-1.

### Example 1-4

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-1.

### Example 1-5

With the exception that the 0.18 weight part of D-glucono-1,5-lactone was changed to 0.18 weight part of D-erythronolactone, a magnetic coating material and magnetic sheet were prepared and evaluated by the same methods as in Example 1-1.

### Example 1-6

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-5.

### Example 1-7

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-5.

### Example 1-8

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-5.

### Example 1-9

With the exception that the 0.18 weight part of D-glucono-1,5-lactone was changed to 0.18 weight part of gulonolactone, a magnetic coating material and magnetic sheet were prepared and evaluated by the same methods as in Example 1-1.

### Example 1-10

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-9.

### Example 1-11

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-9.

### Example 1-12

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-9.

### Comparative Example 1-1

With the exception that D-glucono-1,5-lactone was not employed, a magnetic coating material and magnetic sheet were prepared and evaluated by the same methods as in Example 1-1.

### Comparative Example 1-2

With the exception that D-glucono-1,5-lactone was not employed, a magnetic coating material and magnetic sheet were prepared and evaluated by the same methods as in Example 1-2.

### Comparative Example 1-3

With the exception that D-glucono-1,5-lactone was not employed, a magnetic coating material and magnetic sheet were prepared and evaluated by the same methods as in Example 1-3.

### Comparative Example 1-4

With the exception that D-glucono-1,5-lactone was not employed, a magnetic coating material and magnetic sheet were prepared and evaluated by the same methods as in Example 1-4.

The results of the above evaluation are given in Table 1-1 below.

TABLE 1-1

| | | | Abundance ratio of the binder | | |
|---|---|---|---|---|---|
| | Compound A | | polyurethane on the ferromagnetic | | |
| | (lactone ring-containing | | powder surface/in the coating | | Gel component/ |
| | compound) | Binder | material | Gloss value | sol component |
| Example 1-1 | D-glucono-1,5-lactone | Polymer A | 7.5/1 | 189 | 17.9/1 |
| Example 1-2 | D-glucono-1,5-lactone | Polymer B | 5.7/1 | 107 | 10.0/1 |
| Example 1-3 | D-glucono-1,5-lactone | Polymer C | 5.7/1 | 107 | 10.5/1 |
| Example 1-4 | D-glucono-1,5-lactone | Polymer D | 6.0/1 | 110 | 10.5/1 |
| Example 1-5 | D-erythronolactone | Polymer A | 6.1/1 | 187 | 13.9/1 |
| Example 1-6 | D-erythronolactone | Polymer B | 4.5/1 | 103 | 10.0/1 |
| Example 1-7 | D-erythronolactone | Polymer C | 5.2/1 | 107 | 10.5/1 |
| Example 1-8 | D-erythronolactone | Polymer D | 6.1/1 | 111 | 10.5/1 |
| Example 1-9 | Gulonolactone | Polymer A | 7.7/1 | 185 | 18.1/1 |
| Example 1-10 | Gulonolactone | Polymer B | 5.7/1 | 109 | 10.0/1 |
| Example 1-11 | Gulonolactone | Polymer C | 5.5/1 | 107 | 10.5/1 |
| Example 1-12 | Gulonolactone | Polymer D | 5.9/1 | 110 | 10.5/1 |
| Comp. Ex. 1-1 | None | Polymer A | 2.6/1 | 174 | 5.2/1 |
| Comp. Ex. 1-2 | None | Polymer B | 1.8/1 | 79 | 5.0/1 |
| Comp. Ex. 1-3 | None | Polymer C | 1.7/1 | 75 | 5.0/1 |
| Comp. Ex. 1-4 | None | Polymer D | 2.0/1 | 79 | 5.1/1 |

### 1-2. Examples (Employing Compound A Alone) and Comparative Examples Employing Ferromagnetic Metal Powder

### Example 1-13

A 4.5 weight part quantity of the ferromagnetic metal powder indicated below, 1 weight part of SO₃Na group-containing polymer A (SO₃Na group content: 3.3×10⁻⁴ mole/g), and 0.18 weight part of D-glucono-1,5-lactone were suspended in a solution comprised of 6.8 weight parts of cyclohexanone and 6.3 weight parts of 2-butanone. To the suspension were added 27 weight parts of zirconia beads (made by Nikkato) and the mixture was dispersed for six hours, yielding magnetic coating material 1. To magnetic coating material 1 was added 0.06 weight part of trifunctional polyisocyanate (Coronate L, made by Nippon Polyurethane Industry Co., Ltd.) and the mixture was dispersed for another 10 minutes, yielding magnetic coating material 2. Magnetic coating material 1 was evaluated and a magnetic sheet was prepared and evaluated by the above-described methods.

### Ferromagnetic Metal Powder

Composition Co/Fe: 23.7 atomic %, Y/Fe: 15.3 atomic %, Al/Fe: 9.3 atomic %

Hc: 194 kA/m (2,400 Oe)

Major axis length: 45 nm

Acicular ratio: 4.2

BET specific surface area: 67 m²/g

σs: 110 A·m²/kg (110 emu/g)

pH: 9

### Example 1-14

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-13.

### Example 1-15

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-13.

### Example 1-16

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-13.

### Example 1-17

With the exception that the 0.18 weight part of D-glucono-1,5-lactone was changed to 0.18 weight part of D-erythronolactone, a magnetic coating material and magnetic sheet were prepared and evaluated by the same methods as in Example 1-13.

### Example 1-18

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-17.

### Example 1-19

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-17.

### Example 1-20

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-17.

### Example 1-21

With the exception that the 0.18 weight part of D-glucono-1,5-lactone was changed to 0.18 weight part of gulonolactone, a magnetic coating material and magnetic sheet were prepared and evaluated by the same methods as in Example 1-13.

### Example 1-22

With the exception that the polymer employed was changed from 1 weight part of SO₃Na group-containing polymer A to 1 weight part of SO₃Na group-containing polymer B, a magnetic coating material and magnetic sheet were prepared and evaluated by the same methods as in Example 1-21.

### Example 1-23

With the exception that the polymer employed was changed from 1 weight part of SO₃Na group-containing polymer A to 1 weight part of SO₃Na group-containing polymer C, a magnetic coating material and magnetic sheet were prepared and evaluated by the same methods as in Example 1-21.

### Example 1-24

With the exception that the polymer employed was changed from 1 weight part of SO₃Na group-containing polymer A to 1 weight part of SO₃Na group-containing polymer D, a magnetic coating material and magnetic sheet were prepared and evaluated by the same methods as in Example 1-21.

### Comparative Example 1-5

With the exception that D-glucono-1,5-lactone was not employed, a magnetic coating material and magnetic sheet were prepared and evaluated by the same methods as in Example 1-13.

### Comparative Example 1-6

With the exception that D-glucono-1,5-lactone was not employed, a magnetic coating material and magnetic sheet were prepared and evaluated by the same methods as in Example 1-14.

### Comparative Example 1-7

With the exception that D-glucono-1,5-lactone not was employed, a magnetic coating material and magnetic sheet were prepared and evaluated by the same methods as in Example 1-15.

### Comparative Example 1-8

With the exception that D-glucono-1,5-lactone not was employed, a magnetic coating material and magnetic sheet were prepared and evaluated by the same methods as in Example 1-16.

The results of the above evaluation are given in Table 1-2 below.

TABLE 1-2

| | | | Abundance ratio of the binder | | |
|---|---|---|---|---|---|
| | Compound A | | polyurethane on the ferromagnetic | | |
| | (lactone ring-containing | | powder surface/in the coating | | Gel component/ |
| | compound) | Binder | material | Gloss value | sol component |
| Example1-13 | D-glucono-1,5-lactone | Polymer A | 1.7/1 | 135 | 9.5/1 |
| Example1-14 | D-glucono-1,5-lactone | Polymer B | 1.5/1 | 181 | 13.1/1 |
| Example1-15 | D-glucono-1,5-lactone | Polymer C | 1.5/1 | 185 | 12.5/1 |
| Example1-16 | D-glucono-1,5-lactone | Polymer D | 1.4/1 | 179 | 12.4/1 |
| Example1-17 | D-erythronolactone | Polymer A | 1.7/1 | 133 | 8.8/1 |
| Example1-18 | D-erythronolactone | Polymer B | 1.5/1 | 181 | 12.9/1 |
| Example1-19 | D-erythronolactone | Polymer C | 1.4/1 | 182 | 12.7/1 |
| Example1-20 | D-erythronolactone | Polymer D | 1.5/1 | 185 | 12.7/1 |
| Example1-21 | Gulonolactone | Polymer A | 1.7/1 | 133 | 8.9/1 |
| Example1-22 | Gulonolactone | Polymer B | 1.5/1 | 181 | 12.5/1 |
| Example1-23 | Gulonolactone | Polymer C | 1.5/1 | 185 | 12.6/1 |
| Example1-24 | Gulonolactone | Polymer D | 1.5/1 | 181 | 12.6/1 |
| Comp. Ex. 1-5 | None | Polymer A | 0.74/1 | 120 | 4.3/1 |
| Comp. Ex. 1-6 | None | Polymer B | 0.80/1 | 158 | 8.1/1 |
| Comp. Ex. 1-7 | None | Polymer C | 0.80/1 | 164 | 8.0/1 |
| Comp. Ex. 1-8 | None | Polymer D | 0.90/1 | 163 | 8.3/1 |

### 1-3. Examples (Employing Compound A Alone) and Comparative Examples Employing Nonmagnetic Powder

### Example 1-25

A 4.9 weight part quantity of the nonmagnetic metal powder indicated below, 1 weight part of SO₃Na group-containing polymer A (SO₃Na group content: 3.3×10⁻⁴ mole/g), and 0.18 weight part of D-glucono-1,5-lactone were suspended in a solution comprised of 5.4 weight parts of cyclohexanone and 9.6 weight parts of 2-butanone. To the suspension were added 27 weight parts of zirconia beads (made by Nikkato) and the mixture was dispersed for six hours, yielding nonmagnetic coating material 1. To nonmagnetic coating material 1 was added 0.06 weight part of trifunctional polyisocyanate (Coronate L, made by Nippon Polyurethane Industry Co., Ltd.) and the mixture was dispersed for another 10 minutes, yielding nonmagnetic coating material 2. Nonmagnetic coating material 1 was evaluated and a nonmagnetic sheet was prepared and evaluated by the above-described methods.

### Nonmagnetic Powder

α-Iron oxide

Surface-treatment layer: Al₂O₃, SiO₂

Average major axis length: 0.15 μm

Average acicular ratio: 7

BET specific surface area: 52 m²/g

pH: 8

### Example 1-26

With the exception that the polymer employed was changed from 1 weight part of SO₃Na group-containing polymer A to 1 weight part of SO₃Na group-containing polymer B, a nonmagnetic coating material and nonmagnetic sheet were prepared and evaluated by the same methods as in Example 1-25.

### Example 1-27

With the exception that the polymer employed was changed from 1 weight part of SO₃Na group-containing polymer A to 1 weight part of SO₃Na group-containing polymer C, a nonmagnetic coating material and nonmagnetic sheet were prepared and evaluated by the same methods as in Example 1-25.

### Example 1-28

With the exception that the polymer employed was changed from 1 weight part of SO₃Na group-containing polymer A to 1 weight part of SO₃Na group-containing polymer D, a nonmagnetic coating material and nonmagnetic sheet were prepared and evaluated by the same methods as in Example 1-25.

### Example 1-29

With the exception that the 0.18 weight part of D-glucono-1,5-lactone was changed to 0.18 weight part of D-erythronolactone, a nonmagnetic coating material and nonmagnetic sheet were prepared and evaluated by the same methods as in Example 1-25.

### Example 1-30

With the exception that the polymer employed was changed from 1 weight part of SO₃Na group-containing polymer A to 1 weight part of SO₃Na group-containing polymer B, a nonmagnetic coating material and nonmagnetic sheet were prepared and evaluated by the same methods as in Example 1-29.

### Example 1-31

With the exception that the polymer employed was changed from 1 weight part of SO₃Na group-containing polymer A to 1 weight part of SO₃Na group-containing polymer C, a nonmagnetic coating material and nonmagnetic sheet were prepared and evaluated by the same methods as in Example 1-29.

### Example 1-32

With the exception that the polymer employed was changed from 1 weight part of SO₃Na group-containing polymer A to 1 weight part of SO₃Na group-containing polymer D, a nonmagnetic coating material and nonmagnetic sheet were prepared and evaluated by the same methods as in Example 1-29.

### Example 1-33

With the exception that the 0.18 weight part of D-glucono-1,5-lactone was changed to 0.18 weight part of gulonolactone, a nonmagnetic coating material and nonmagnetic sheet were prepared and evaluated by the same methods as in Example 1-25.

### Example 1-34

With the exception that the polymer employed was changed from 1 weight part of SO₃Na group-containing polymer A to 1 weight part of SO₃Na group-containing polymer B, a nonmagnetic coating material and nonmagnetic sheet were prepared and evaluated by the same methods as in Example 1-33.

### Example 1-35

With the exception that the polymer employed was changed from 1 weight part of SO₃Na group-containing polymer A to 1 weight part of SO₃Na group-containing polymer C, a nonmagnetic coating material and nonmagnetic sheet were prepared and evaluated by the same methods as in Example 1-33.

### Example 1-36

With the exception that the polymer employed was changed from 1 weight part of SO₃Na group-containing polymer A to 1 weight part of SO₃Na group-containing polymer D, a nonmagnetic coating material and nonmagnetic sheet were prepared and evaluated by the same methods as in Example 1-33.

### Comparative Example 1-9

With the exception that D-glucono-1,5-lactone was not employed, a nonmagnetic coating material and nonmagnetic sheet were prepared and evaluated by the same methods as in Example 1-25.

### Comparative Example 1-10

With the exception that D-glucono-1,5-lactone was not employed, a nonmagnetic coating material and nonmagnetic sheet were prepared and evaluated by the same methods as in Example 1-26.

### Comparative Example 1-11

With the exception that D-glucono-1,5-lactone was not employed, a nonmagnetic coating material and nonmagnetic sheet were prepared and evaluated by the same methods as in Example 1-27.

### Comparative Example 1-12

With the exception that D-glucono-1,5-lactone was not employed, a nonmagnetic coating material and nonmagnetic sheet were prepared and evaluated by the same methods as in Example 1-28.

The results of the above evaluation are given in Table 1-3 below.

TABLE 1-3

| | Compound A | | Abundance ratio of the binder | | |
|---|---|---|---|---|---|
| | (lactone | | polyurethane on the nonmagnetic | | |
| | ring-containing | | powder surface/in the coating | | Gel component/ |
| | compound) | Binder | material | Gloss value | sol component |
| Example 1-25 | D-glucono-1,5-lactone | Polymer A | 0.41/1 | 135 | 8.1/1 |
| Example 1-26 | D-glucono-1,5-lactone | Polymer B | 1.5/1 | 199 | 7.9/1 |
| Example 1-27 | D-glucono-1,5-lactone | Polymer C | 1.4/1 | 185 | 7.5/1 |
| Example 1-28 | D-glucono-1,5-lactone | Polymer D | 1.5/1 | 180 | 7.6/1 |
| Example 1-29 | D-erythronolactone | Polymer A | 0.40/1 | 137 | 8.0/1 |
| Example 1-30 | D-erythronolactone | Polymer B | 1.5/1 | 213 | 10.1/1 |
| Example 1-31 | D-erythronolactone | Polymer C | 1.4/1 | 185 | 10.5/1 |
| Example 1-32 | D-erythronolactone | Polymer D | 1.5/1 | 191 | 10.5/1 |
| Example 1-33 | Gulonolactone | Polymer A | 0.40/1 | 130 | 8.0/1 |
| Example 1-34 | Gulonolactone | Polymer B | 1.5/1 | 195 | 7.9/1 |
| Example 1-35 | Gulonolactone | Polymer C | 1.4/1 | 193 | 7.5/1 |
| Example 1-36 | Gulonolactone | Polymer D | 1.5/1 | 180 | 7.6/1 |
| Comp. Ex. 1-9 | None | Polymer A | 0.22/1 | 113 | 4.1/1 |
| Comp. Ex. 1-10 | None | Polymer B | 0.75/1 | 164 | 6.9/1 |
| Comp. Ex. 1-11 | None | Polymer C | 0.79/1 | 175 | 6.5/1 |
| Comp. Ex. 1-12 | None | Polymer D | 0.80/1 | 170 | 6.6/1 |

The following determinations were made based on a comparison of Examples and Comparative Examples in which identical binders were employed in Tables 1-1 to 1-3.

(1) The lactone ring-containing compound, compound A, comprising a prescribed polar group that was employed in the Example modified the surface of the powder and increased the level of binder adsorption. Since the increase in the level of binder absorption to the powder in the coating material involved improvement in the dispersibility of the powder, compound A employed in Example was confirmed to function as a dispersing agent in the magnetic coating material and nonmagnetic coating material.

(2) The sheets prepared in Example exhibited a higher degree of gloss than the sheets prepared in Comparative Example. Thus, compound A employed in Example was found to exhibit the effect of increasing powder dispersion.

(3) The gel component of the sheet prepared in Example was greater than the gel component of the magnetic sheet prepared in Comparative Example. Thus, the sheet prepared in Example was determined to have a higher coating strength than the sheet prepared in Comparative Example. The hydroxyl group contained in compound A employed in Example was thought to have enhanced the coating strength by forming a crosslinked structure with the isocyanate group of the isocyanate.

### 1-4. Examples (Employing Compound A Alone) and Comparative Examples of Magnetic Recording Media

### Example 1-37

(1) Preparation of Magnetic Recording Medium

Magnetic layer coating liquid

| | | |
|---|---|---|
| Hexagonal barium ferrite powder: | 100 | parts |
| Composition excluding oxygen (mole ratio): | | |
| Ba/Fe/Co/Zn = 1/9/0.2/1 | | |
| Hc: 176 kA/m (2,200 Oe) | | |
| Average plate diameter: 20 nm | | |
| Average plate ratio: 3 | | |
| BET specific surface area: 65 m²/g | | |
| σs: 49 A · m²/kg (49 emu/g) | | |
| pH: 7 | | |
| Polyurethane resin based on branch side | 17 | parts |
| chain-comprising polyester polyol/ | | |
| diphenylmethane diisocyanate: | | |
| —SO₃Na = 0.6 mmole/g | | |
| D-Glucono-1,5-lactone: | 5 | parts |
| α-Alumina (particle size 0.15 μm): | 5 | parts |
| Diamond powder (average particle diameter 60 nm): | 1 | part |
| Carbon black (average particle diameter 20 nm): | 1 | part |
| Cyclohexanone: | 110 | parts |
| Methyl ethyl ketone: | 110 | parts |
| Butyl stearate: | 2 | parts |
| Stearic acid: | 1 | part |

Nonmagnetic layer coating liquid

| | | |
|---|---|---|
| Nonmagnetic inorganic powder: | 85 | parts |
| α-Iron oxide | | |
| Surface treatment layer: Al₂O₃, SiO₂ | | |
| Average major axis length: 0.15 μm | | |
| Average acicular ratio: 7 | | |
| BET specific surface area: 52 m²/g | | |
| pH: 8 | | |
| Carbon black: | 15 | parts |
| Vinyl chloride copolymer (MR110, made | 10 | parts |
| by Zeon Corporation): | | |
| Polyurethane resin based on branch side | 10 | parts |
| chain-comprising polyester polyol/ | | |
| diphenylmethane diisocyanate: | | |
| —SO₃Na = 0.2 mmole/g | | |
| Phenyl phosphonic acid: | 3 | parts |
| Cyclohexanone: | 140 | parts |
| Methyl ethyl ketone: | 170 | parts |
| Butyl stearate: | 2 | parts |
| Stearic acid: | 1 | part |

The various components of the above nonmagnetic layer coating liquid were kneaded in an open kneader and dispersed in a sand mill. To the dispersion obtained were added 5 parts of polyisocyanate (Coronate L, made by Nippon Polyurethane Industry Co., Ltd.), followed by 40 parts of a mixed solvent of methyl ethyl ketone and cyclohexanone. The mixture was then filtered through a filter having a pore size of 1 μm to prepare a nonmagnetic layer coating liquid.

For the magnetic layer coating liquid, the hexagonal ferrite powder, D-glucono-1,5-lactone, and polyurethane resin were kneaded along with the other magnetic layer coating liquid components in an open kneader and dispersed in a sand mill. To the dispersion obtained were added 40 parts of a mixed solvent of methyl ethyl ketone and cyclohexanone. The mixture was then filtered through a filter having a pore size of 1 μm to prepare a magnetic layer coating liquid.

The nonmagnetic layer coating liquid and the magnetic layer coating liquid obtained were simultaneously multilayer coated on a support 7 μm in thickness (biaxially oriented polyethylene terephthalate) such that the film thickness of the nonmagnetic layer was 1.5 μm upon drying, the film thickness of the magnetic layer was 0.15 μm upon drying, and the total tape thickness was 8.7 μm upon drying. While the two layers were still wet, orientation was conducted with a cobalt magnet having a 0.3 T (300 G) magnetic force and solenoid having a 0.15 T (1,500 G) magnetic force, and the layers were dried. Calendering was subsequently conducted with a seven-stage calender comprised of just metal rolls at a speed of 100 m/min, a linear pressure of 350 kg/cm (343 kN/m), and a temperature of 90° C., after which the product was slit to a width of ½ inch to prepare a magnetic tape.

Evaluation Methods

(1) Determination of Adsorption to Magnetic Powder

The abundance ratio of the polyurethane in the magnetic layer coating liquid prepared on the ferromagnetic powder surface/in the liquid was measured by the method set forth above.

(2) Surface Roughness

The surface roughness of the magnetic tape obtained was measured by the following method.

The centerline average surface roughness Ra of the magnetic layer of the magnetic tape was determined by the scanning white light interference method with a general-purpose three-dimensional surface structure analyzer, the NewView 5022 made by Zygo Corp. at a scan length of 5 μm with a 20-fold magnification object lens, a 1.0-fold magnification zoom lens, a measurement viewfield of 260 μm×350 μm, and a measured surface was subjected to filtering process of HPF: 1.65 μm and LPF: 50 μm to obtain the Ra value.

(3) Head Grime

After running the tape by the following method, the contact sliding surface of the head member with the tape was observed with a Nikon HFX-II and the presence or absence of adhered material was determined.

(Running Method)

A single-roll, 800 m tape sample was wound and unwound reel-to-reel with a magnetic tape tester at a running speed of 6 m/s, a back tension of 0.7 N, and a tape/head angle (½ the lap angle) of 10 degrees.

### (4) Rubbing Scratch Test

Spherical balls (made of alumina) ¼ in diameter (manufactured by Nihon Ceratec) were employed to make 20 rubbing passes per track at a load of 20 gf over the tape. The presence or absence of rubbing scratches on the surface of the tape was then visually determined with a Nikon HFX-II.

### Comparative Example 1-13

With the exception that D-glucono-1,5-lactone was not added to the magnetic layer, a magnetic tape was prepared and evaluated by the same methods as in Example 1-37.

The results of the above evaluation are given in Table 1-4 below.

TABLE 1-4

| | Abundance ratio of poly- | | | |
|---|---|---|---|---|
| | urethane on the ferro- | Surface | Presence or absence | Presence or absence |
| | magnetic powder/in magnetic | roughness | of material adhered | of rubbing scratch |
| | layer coating liquid | Ra | to head | by alumina |
| Example 1-37 | 7.0/1 | 2.17 nm | None | None |
| Comp. Ex. 1-13 | 2.3/1 | 2.32 nm | Observed | Observed |

As indicated in Table 1-4, Example 1-37 had a magnetic layer with a smoother surface than that in Comparative Example 1-13. This was attributed to the surface modifying effect of D-glucono-1,5-lactone on the ferromagnetic powder, which increased the level of polyurethane adsorption to the surface of the ferromagnetic powder, enhancing ferromagnetic powder dispersion. The reason no material adhered to the head and no alumina scratching occurred in Example 1-37 was attributed to the hydroxyl groups contained in the D-glucono-1,5-lactone forming a crosslinked structure with the isocyanate groups in the isocyanate and thus enhancing the coating strength.

### 2-1. Examples (Employing Compounds A and B) and Comparative Examples Employing Ferromagnetic Hexagonal Ferrite Powder

### Example 2-1

(1) Preparation of Magnetic Coating Material

A 2.2 weight part quantity of the ferromagnetic hexagonal ferrite powder indicated below, 1 weight part of SO₃Na group-comprising polymer B, 0.18 weight part of D-glucono-1,5-lactone, and 0.12 weight part of 1-naphthoic acid were suspended in a solution comprised of 3.3 weight parts of cyclohexanone and 4.9 weight parts of 2-butanone. To the suspension were added 27 weight parts of zirconia beads (made by Nikkato) and the mixture was dispersed for six hours, yielding magnetic coating material 1. To magnetic coating material 1 was added 0.06 weight part of trifunctional isocyanate (Coronate L, made by Nippon Polyurethane Industry Co., Ltd.) and the mixture was dispersed for another 10 minutes, yielding magnetic coating material 2.

### Ferromagnetic Hexagonal Barium Ferrite Powder

Composition excluding oxygen (mole ratio): Ba/Fe/Co/Zn=1/9/0.2/1

Hc: 176 kA/m (2,200 Oe)

Average plate diameter: 25 nm

Average plate ratio: 3

BET specific surface area: 65 m²/g

σs: 49 A·m²/kg (49 emu/g)

pH: 7

(2) Confirmation of Adsorption to Magnetic Powder

The abundance ratio of the binder (polymer B) in magnetic coating material 1 obtained in (1) above on the ferromagnetic powder surface/in the coating material was measured by the methods described above.

(3) Preparation and Evaluation of Magnetic Sheet

Magnetic coating material 2 obtained in (1) above was employed to prepare and evaluate a magnetic sheet by the method described above. Table 2-1 gives the ratio of the gel component/sol component obtained.

### Example 2-2

With the exception that the polymer employed was changed from 1 weight part of SO₃Na group-containing polymer B to 1 weight part of SO₃Na group-containing polymer C, a magnetic coating material and magnetic sheet were prepared and evaluated by the same methods as in Example 2-1.

### Example 2-3

With the exception that the polymer employed was changed from 1 weight part of SO₃Na group-containing polymer B to 1 weight part of SO₃Na group-containing polymer D, a magnetic coating material and magnetic sheet were prepared and evaluated by the same methods as in Example 2-1.

### Example 2-4

With the exception that 1 weight part of 1-napthoic acid was changed to 1 weight part of oleic acid, a magnetic coating material and magnetic sheet were prepared and evaluated by the same methods as in Example 2-1.

### Example 2-5

With the exception that 1 weight part of 1-napthoic acid was changed to 1 weight part of oleic acid, a magnetic coating material and magnetic sheet were prepared and evaluated by the same methods as in Example 2-2.

### Example 2-6

With the exception that 1 weight part of 1-napthoic acid was changed to 1 weight part of oleic acid, a magnetic coating material and magnetic sheet were prepared and evaluated by the same methods as in Example 2-3.

### Comparative Example 2-1

With the exceptions that D-glucono-1,5-lactone and 1-naphthoic acid were not employed, a magnetic coating material and magnetic sheet were prepared and evaluated by the same methods as in Example 2-1.

### Comparative Example 2-2

With the exceptions that D-glucono-1,5-lactone and 1-naphthoic acid were not employed, a magnetic coating material and magnetic sheet were prepared and evaluated by the same methods as in Example 2-2.

### Comparative Example 2-3

With the exceptions that D-glucono-1,5-lactone and 1-naphthoic acid were not employed, a magnetic coating material and magnetic sheet were prepared and evaluated by the same methods as in Example 2-3.

The results of the above evaluation are given in Table 2-1.

TABLE 2-1

| | | | | Abundance ratio of the | | |
|---|---|---|---|---|---|---|
| | | | | binder polyurethane on | | |
| | | | | the ferromagnetic | | |
| | | | | powder surface/in the | | Gel component/ |
| | Compound A | Compound B | Binder | coating material | Gloss value | sol component |
| Example 2-1 | D-glucono-1,5-lactone | 1-naphthoic acid | Polymer B | 5.7/1 | 175 | 10.0/1 |
| Example 2-2 | D-glucono-1,5-lactone | 1-naphthoic acid | Polymer C | 5.7/1 | 180 | 10.5/1 |
| Example 2-3 | D-glucono-1,5-lactone | 1-naphthoic acid | Polymer D | 6.0/1 | 170 | 10.5/1 |
| Example 2-4 | D-glucono-1,5-lactone | Oleic acid | Polymer B | 6.0/1 | 180 | 10.5/1 |
| Example 2-5 | D-glucono-1,5-lactone | Oleic acid | Polymer C | 5.7/1 | 181 | 10.5/1 |
| Example 2-6 | D-glucono-1,5-lactone | Oleic acid | Polymer D | 6.0/1 | 179 | 10.5/1 |
| Comp. Ex. 2-1 | None | None | Polymer B | 2.6/1 | 174 | 5.2/1 |
| Comp. Ex. 2-2 | None | None | Polymer C | 1.8/1 | 79 | 5.0/1 |
| Comp. Ex. 2-3 | None | None | Polymer D | 1.7/1 | 75 | 5.0/1 |

### 2-2. Examples (Employing Compounds A and B) and Comparative Examples Employing Nonmagnetic Powder

### Example 2-7

A 4.9 weight part quantity of the nonmagnetic metal powder indicated below, 1 weight part of SO₃Na group-containing polymer A, 0.18 weight part of D-erythronolactone, and 0.15 weight part of cinnamic acid were suspended in a solution comprised of 5.4 weight parts of cyclohexanone and 9.6 weight parts of 2-butanone. To the suspension were added 27 weight parts of zirconia beads (made by Nikkato) and the mixture was dispersed for six hours, yielding nonmagnetic coating material 1. To nonmagnetic coating material 1 was added 0.06 weight part of trifunctional polyisocyanate (Coronate L, made by Nippon Polyurethane Industry Co., Ltd.) and the mixture was dispersed for another 10 minutes, yielding nonmagnetic coating material 2. Nonmagnetic coating material 1 was evaluated and a nonmagnetic sheet was prepared and evaluated by the above-described methods.

### Nonmagnetic Powder

α-Iron oxide

Surface-treatment layer: Al₂O₃, SiO₂

Average major axis length: 0.15 μm

Average acicular ratio: 7

BET specific surface area: 52 m²/g

pH: 8

### Example 2-8

With the exception that the polymer employed was changed from 1 weight part of SO₃Na group-containing polymer A to 1 weight part of SO₃Na group-containing polymer B, a nonmagnetic coating material and nonmagnetic sheet were prepared and evaluated by the same methods as in Example 2-7.

### Example 2-9

With the exception that the polymer employed was changed from 1 weight part of SO₃Na group-containing polymer A to 1 weight part of SO₃Na group-containing polymer C, a nonmagnetic coating material and nonmagnetic sheet were prepared and evaluated by the same methods as in Example 2-7.

### Example 2-10

With the exception that the polymer employed was changed from 1 weight part of SO₃Na group-containing polymer A to 1 weight part of SO₃Na group-containing polymer D, a nonmagnetic coating material and nonmagnetic sheet were prepared and evaluated by the same methods as in Example 2-7.

### Comparative Example 2-4

With the exceptions that D-erythronolactone and cinnamic acid were not employed, a nonmagnetic coating material and nonmagnetic sheet were prepared and evaluated by the same methods as in Example 2-7.

### Comparative Example 2-5

With the exceptions that D-erythronolactone and cinnamic acid were not employed, a nonmagnetic coating material and nonmagnetic sheet were prepared and evaluated by the same methods as in Example 2-8.

### Comparative Example 2-6

With the exceptions that D-erythronolactone and cinnamic acid were not employed, a nonmagnetic coating material and nonmagnetic sheet were prepared and evaluated by the same methods as in Example 2-9.

### Comparative Example 2-7

With the exceptions that D-erythronolactone and cinnamic acid were not employed, a nonmagnetic coating material and nonmagnetic sheet were prepared and evaluated by the same methods as in Example 2-10.

The results of the above evaluation are given in Table 2-2 below.

TABLE 2-2

| | | | | Abundance ratio of | | |
|---|---|---|---|---|---|---|
| | | | | the binder | | |
| | | | | polyurethane on the | | |
| | | | | nonmagnetic | | |
| | | | | powder surface/in | | Gel component/ |
| | Compound A | CompoundB | Binder | the coating material | Gloss value | sol component |
| Example 2-7 | D-erythronolactone | Cinnamic acid | Polymer A | 1.1/1 | 140 | 11.0/1 |
| Example 2-8 | D-erythronolactone | Cinnamic acid | Polymer B | 1.8/1 | 220 | 10.1/1 |
| Example 2-9 | D-erythronolactone | Cinnamic acid | Polymer C | 2.0/1 | 214 | 10.5/1 |
| Example 2-10 | D-erythronolactone | Cinnamic acid | Polymer D | 1.7/1 | 195 | 10.5/1 |
| Comp. Ex. 2-4 | None | None | Polymer A | 0.80/1 | 130 | 8.0/1 |
| Comp. Ex. 2-5 | None | None | Polymer B | 0.40/1 | 130 | 8.0/1 |
| Comp. Ex. 2-6 | None | None | Polymer C | 0.40/1 | 130 | 8.0/1 |
| Comp. Ex. 2-7 | None | None | Polymer D | 0.40/1 | 130 | 8.0/1 |

The following determinations were made based on a comparison of Examples and Comparative Examples in which identical binders were employed in Tables 2-1 to 2-2.

(1) The use of compounds A and B modified the surface of the powder and increased the level of binder adsorption. Since the increase in the level of binder absorption to the powder in the coating material involved improvement in the dispersibility of the powder, the combination of compounds A and B employed in the Example was confirmed to function as a dispersing agent in the magnetic coating material and nonmagnetic coating material.

(2) The sheet prepared in the Example exhibited a higher degree of gloss than the sheet prepared in Comparative Example. Thus, the combination of compounds A and B employed in the Example was found to exhibit the effect of increasing powder dispersion.

(3) The gel component of the sheet prepared in Example was larger than the gel component of the magnetic sheet prepared in Comparative Example. Thus, the sheet prepared in Example was determined to have a higher coating strength than the sheet prepared in Comparative Example. The hydroxyl group contained in compound A employed in Example was thought to have enhanced the coating strength by forming a crosslinked structure with the isocyanate group of the isocyanate.

### 2-3. Examples (Employing both Compounds A and B) and Comparative Examples of Preparation of Magnetic Tape

### Example 2-11

(1) Preparation of Magnetic Coating Material

A 4.5 part quantity of the ferromagnetic metal powder indicated below, 0.68 part of sulfonic acid group-containing polyurethane (—SO₃Na group content: 0.6×10⁻⁴ mole/g), 0.32 part of vinyl chloride copolymer (—SO₃K group content: 1.2×10⁻⁴ mole/g), 0.11 part of trans-cinammic acid, and 0.063 part of D-glucono-1,5-lactone were suspended in a solution comprised of 6.8 parts of cyclohexanone and 6.3 parts of 2-butanone. To the suspension were added 27 weight parts of zirconia beads (made by Nikkato) and the mixture was dispersed for six hours. A 0.20 weight part quantity of trifunctional isocyanate (Coronate L, made by Nippon Polyurethane Industry Co., Ltd.) was added, and the mixture was dispersed for another 15 minutes, yielding a magnetic coating material.

### Ferromagnetic Metal Powder

Composition Co/Fe: 23.7 atomic %, Y/Fe: 15.3 atomic %, Al/Fe: 9.3 atomic %

Hc: 194 kA/m (2,400 Oe)

Major axis length: 45 nm

Acicular ratio: 4.2

BET specific surface area: 67 m²/g

σs: 110 A·m²/kg (110 emu/g)

pH: 9

(2) Preparation of Magnetic Tape Sample A

The above magnetic coating material was coated and dried to a dry thickness of 0.4 μm on a support comprised of polyethylene terephthalate 5.0 μm in thickness, calendered, subjected to a heat stabilization treatment, and slit to ½ inch width to prepare sample A.

(3) Preparation of Nonmagnetic Coating Material

| Component 1 | | |
|---|---|---|
| Iron oxide powder (particle diameter: 0.15 μm × 0.02 μm): | 70 | parts |
| Alumina (α-conversion rate: 50 percent, particle diameter: | 8 | parts |
| 0.05 μm): | | |
| Carbon black (particle diameter: 15 nm): | 25 | parts |
| Stearic acid/butyl stearate (50/50 (weight ratio)): | 3.0 | parts |
| Vinyl chloride copolymer (—SO₃Na group content: 1.2 × | 10 | parts |
| 10⁻⁴ equivalent/g): | | |
| Polyester polyurethane resin (Tg: 40° C., —SO₃Na group | 4.4 | parts |
| content: 1 × 10⁻⁴ equivalent/g): | | |
| Cyclohexanone: | 30 | parts |
| Methyl ethyl ketone: | 60 | parts |
| Component 2 | | |
| Butyl stearate: | 3 | parts |
| Oleyl oleate: | 5 | parts |
| Cyclohexanone: | 40 | parts |
| Methyl ethyl ketone: | 60 | parts |
| Toluene: | 15 | parts |
| Component 3 | | |
| Trifunctional isocyanate (Coronate L, made by Nippon | 1.5 | parts |
| Polyurethane Industry Co., Ltd.): | | |
| Cyclohexanone: | 8 | parts |
| Methyl ethyl ketone: | 18 | parts |
| Toluene | 8 | parts |

Of the above components, component 1 was kneaded in a kneader, component 2 was added, and the mixture was stirred. The mixture was then dispersed for a retention time of 90 minutes in a sand mill. Component 3 was added and the mixture was stirred and filtered to prepare a nonmagnetic coating material.

(4) Preparation of Magnetic Tape Sample B

The above nonmagnetic coating material was coated to a dry thickness of 1.0 μm on a support comprised of polyethylene terephthalate 5.0 μm in thickness. The magnetic coating material prepared in (1) above was coated thereover, dried, calendered, subjected to a heat stabilization treatment, and slit to ½ inch width to prepare sample B.

### Comparative Example 2-8

With the exception that the 0.063 part of D-glucono-1,5-lactone employed as a magnetic coating material component in Example 2-11 was replaced with 0.068 part of citric acid, sample C was prepared by directly coating the magnetic coating material on the support and sample D was prepared by coating the nonmagnetic coating material and the magnetic coating material by the same method as in Example 2-11.

### Comparative Example 2-9

With the exception that the magnetic coating material component in the form of D-glucono-1,5-lactone was not employed, sample E was prepared by directly coating the magnetic coating material on the support and sample F was prepared by coating the nonmagnetic coating material and magnetic coating material by the same method as in Example 2-11.

Evaluation Methods

<Squareness>

A test piece 12 mm×32 mm in size was cut from each sample. A high sensitivity magnetization vector measuring device made by Toei Industry Co., Ltd. and a data processor made by the same company were employed to measure the squareness under conditions of an applied magnetic field of 796 kA/m (10 kOe).

<Surface Roughness of Magnetic Layer>

The centerline average surface roughness Ra of the magnetic layer was measured by the scanning white light interference method with a general-purpose three-dimensional surface structure analyzer, the NewView 5000 made by Zygo Corp. at a scan length of 5 μm with a measurement viewfield of 350 μm×260 μm.

<Amount of Adhesion to Sapphire Blade>

The magnetic surface of a product slit to ½ inch width was brought into contact with the edge of a triangular prism made of sapphire at a touch angle of 12 degrees, and the product slit to ½ inch width was run at a tension of 100 g and a speed of 3 m/s. The amount of material adhering to the edge line of the sapphire blade was evaluated by observation under a microscope.

The various evaluation items and samples evaluated are given in Table 2-3.

TABLE 2-3

| | | Surface roughness | |
|---|---|---|---|
| | | Ra of magnetic | Material adhering |
| | Squareness | layer | to sapphire blade |
| Example 2-11 | Sample A | Sample A | Sample B |
| Comp. Example 2-8 | Sample C | Sample C | Sample D |
| Comp. Example 2-9 | Sample E | Sample E | Sample F |

The results of the above evaluation are given in Table 2-4 below.

TABLE 2-4

| | | Surface roughness | |
|---|---|---|---|
| | | of magnetic layer | Material adhering |
| | Squareness | (nm) | to sapphire blade |
| Example 2-11 | 0.826 | 2.9 | ◯ |
| Comp. Example 2-8 | 0.804 | 3.3 | X |
| Comp. Example 2-9 | 0.816 | 4.6 | XX |

Amount of material adhering to sapphire blade:
◯: None
X: Over entire edge line
XX: Accumulated

As indicated in Table 2-4, a smooth magnetic layer was formed in Example 2-11. It was thus determined that the combined use of compounds A and B enhanced the dispersion of the magnetic powder. In Example 2-11, a higher degree of squareness was exhibited than in Comparative Examples 2-8 and 2-9. Since the squareness tended to increase with improvement in the dispersibility of a magnetic powder, the fact that a high degree of squareness was obtained confirmed that the combined use of compounds A and B improved the dispersibility of the magnetic powder. Since no material adhering to the sapphire blade was observed in Example 2-11, the magnetic layer formed in Example 2-11 was determined to have good coating strength.

Compound A and the combination of compound A and B are suitable for use as a dispersing agent for coating liquids for forming magnetic and nonmagnetic layers of the magnetic recording medium.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium comprising a magnetic layer comprising a ferromagnetic powder and a binder on a nonmagnetic support, wherein
the magnetic layer comprises a compound, referred to as “compound A”, hereinafter, and/or a ring-opened product of compound A, compound A comprising a lactone ring substituted with at least one polar group selected from the group consisting of a hydroxyl group, a carboxyl group, and an amino group, or substituted with a substituent comprising the polar group.

2. The magnetic recording medium according to claim 1, wherein the magnetic layer further comprises a compound, referred to as “compound B”, hereinafter, comprising an unsaturated bond and a carboxyl group.

3. The magnetic recording medium according to claim 1, wherein compound A is a compound denoted by general formula (I) or (II): 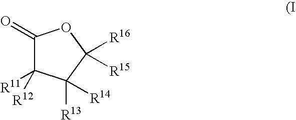
wherein, in general formula (I), each of R¹¹ to R¹⁶ independently denotes a hydrogen atom or a substituent, with at least one from among R¹¹ to R¹⁶ denoting at least one polar group selected from the group consisting of a hydroxyl group, carboxyl group, and amino group, or a substituent comprising the polar group; 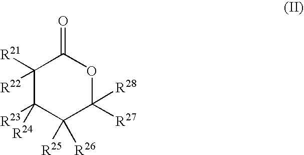
wherein, in general formula (II), each of R²¹ to R²⁸ independently denotes a hydrogen atom or a substituent, with at least one from among R²¹ to R²⁸ denoting at least one polar group selected from the group consisting of a hydroxyl group, carboxyl group, and amino group, or a substituent comprising the polar group.

4. The magnetic recording medium according to claim 1, wherein the polar group comprised in compound A is a hydroxyl group.

5. The magnetic recording medium according to claim 1, wherein compound A comprises at least two hydroxyl groups per molecule.

6. The magnetic recording medium according to claim 2, wherein compound B is an unsaturated fatty acid.

7. The magnetic recording medium according to claim 2, wherein compound B is an aromatic compound.

8. The magnetic recording medium according to claim 7, wherein the aromatic compound comprises a benzene ring or naphthalene ring.

9. The magnetic recording medium according to claim 1, wherein the magnetic layer comprises a reaction product of compound A and/or the ring-opened product of compound A with an isocyanate compound.

10. A magnetic recording medium comprising a nonmagnetic layer comprising a nonmagnetic powder and a binder and a magnetic layer comprising a ferromagnetic powder and a binder in this order on a nonmagnetic support, wherein
the nonmagnetic layer comprises a compound, referred to as “compound A”, hereinafter, and/or a ring-opened product of compound A, compound A comprising a lactone ring substituted with at least one polar group selected from the group consisting of a hydroxyl group, a carboxyl group, and an amino group, or substituted with a substituent comprising the polar group.

11. The magnetic recording medium according to claim 10, wherein the nonmagnetic layer further comprises a compound, referred to as “compound B”, hereinafter, comprising an unsaturated bond and a carboxyl group.

12. The magnetic recording medium according to claim 10, wherein compound A is a compound denoted by general formula (I) or (II): 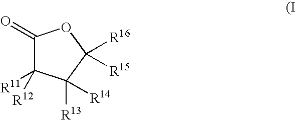
wherein, in general formula (I), each of R¹¹ to R¹⁶ independently denotes a hydrogen atom or a substituent, with at least one from among R¹¹ to R¹⁶ denoting at least one polar group selected from the group consisting of a hydroxyl group, carboxyl group, and amino group, or a substituent comprising the polar group; 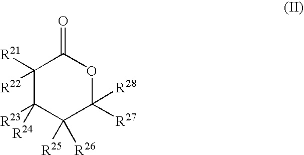
wherein, in general formula (II), each of R²¹ to R²⁸ independently denotes a hydrogen atom or a substituent, with at least one from among R²¹ to R²⁸ denoting at least one polar group selected from the group consisting of a hydroxyl group, carboxyl group, and amino group, or a substituent comprising the polar group.

13. The magnetic recording medium according to claim 10 wherein the polar group comprised in compound A is a hydroxyl group.

14. The magnetic recording medium according to claim 10, wherein compound A comprises at least two hydroxyl groups per molecule.

15. The magnetic recording medium according to claim 11, wherein compound B is an unsaturated fatty acid.

16. The magnetic recording medium according to claim 11, wherein compound B is an aromatic compound.

17. The magnetic recording medium according to claim 16, wherein the aromatic compound comprises a benzene ring or naphthalene ring.

18. The magnetic recording medium according to claim 10, wherein the nonmagnetic layer comprises a reaction product of compound A and/or the ring-opened product of compound A with an isocyanate compound.

19. The magnetic recording medium according to claim 10, wherein the magnetic layer comprises compound A and/or a ring-opened product of compound A, and/or a reaction product thereof with an isocyanate compound.

20. The magnetic recording medium according to claim 19, wherein the nonmagnetic layer further comprises a compound comprising an unsaturated bond and a carboxyl group.
